(19) United States
(12) Patent Application Publication
(10) Pub. No.: US 2024/0062541 A1
(43) Pub. Date: Feb. 22, 2024

(54) DETECTION SYSTEM, DETECTION METHOD, AND RECORDING MEDIUM

(71) Applicant: NEC Corporation, Minato-ku, Tokyo (JP)

(72) Inventors: Masaya FUJIWAKA, Tokyo (JP); Hideyuki SHIMONISHI, Tokyo (JP)

(73) Assignee: NEC Corporation, Minato-ku, Tokyo (JP)

(21) Appl. No.: 18/270,742

(22) PCT Filed: Jan. 6, 2022
(86) PCT No.: PCT/JP2022/000153

§ 371 Date: Jul. 3, 2023

(30) Foreign Application Priority Data
Jan. 12, 2021 (JP) 2021-003113

(51) Int. Cl. G06V 20/20; G01C 21/16; G06T 7/60; G06T 7/70

(52) U.S. Cl. CPC G06V 20/20; G01C 21/16; G06T 7/60; G06T 7/70; G06T 2207/10016

(57) ABSTRACT

Accuracy of detection of an object existing in a reality space is improved. A detection system includes: a first detecting section (11) which detects an object with reference to a value detected by a first sensor; a second detecting section (12) which detects the object with reference to a result of previous detection of the object; an integrating section (14) which detects the object by integrating a result of detection by the first detecting section (11) and a result of detection by the second detecting section (12).

### TECHNICAL FIELD

The present invention relates to a technique of detecting an object existing in a reality space.

### BACKGROUND ART

A technique of detecting an object existing in a reality space is known. Such a technique is used in, for example, augmented reality (AR). In AR, an object existing in a reality space is detected, and a virtual object is disposed in a place where the detected object exists. Further, in AR, the virtual object is superimposed on an image of the reality space which image is captured by a camera of a user terminal, and the image is displayed on a display of the user terminal.

As a technique of detecting an object existing in a reality space, a video recognition technique of detecting, in a captured image, an area that matches a preregistered feature of an object is well known.

Another technique of detecting an object existing in a reality space is disclosed in Non-Patent Literature 1. In the technique disclosed in Non-Patent Literature 1, on the basis of (i) a position and a direction of a terminal that are specified with use of a sensor and (ii) preregistered information pertaining to a position of an object in a target space, the object existing in the target space is detected.

### CITATION LIST

### Non-Patent Literature

[Non-Patent Literature 1]
Chen, Kaifei, et al. “Marvel: Enabling mobile augmented reality with low energy and low latency.” Proceedings of the 16th ACM Conference on Embedded Networked Sensor Systems. 2018.

### SUMMARY OF INVENTION

### Technical Problem

The video recognition technique and the technique disclosed in Non-Patent Literature 1 each have room for improvement in accuracy of detection of an object. Reasons for this are as follows. In a case where the video recognition technique is used in AR, it is required that a processing time, from when a camera captures an image of a reality space to when the captured image on which a virtual object is superimposed is displayed, be short. However, there is a possibility that a highly-accurate video recognition technique cannot be used to detect an object at a high speed. Therefore, there is a case where an object cannot be accurately recognized. In the technique disclosed in Non-Patent Literature 1, preregistered information pertaining to a position of an object is used. Therefore, it is difficult to accurately recognize a moving object.

An example aspect of the present invention has been made in view of the above problems, and an example object thereof is to provide a technique of improving accuracy of detection of an object existing in a reality space.

### Solution to Problem

A detection system according to an example aspect of the present invention includes: a first detecting means for detecting an object with reference to a value detected by a first sensor; a second detecting means for detecting the object with reference to a result of previous detection of the object; and an integrating means for detecting the object by integrating a result of detection by the first detecting means and a result of detection by the second detecting means.

A detection method according to an example aspect of the present invention includes: detecting an object existing in a reality space, with reference to a value detected by a first sensor; detecting the object with reference to a result of previous detection of the object; and detecting the object by integrating (i) a result of detection which has been carried out with reference to the value detected by the first sensor and (ii) a result of detection which has been carried out with reference to the result of the previous detection.

A program according to an example aspect of the present invention is a program for causing a computer to function as a detection system, the program causing the computer to function as: a first detecting means for detecting an object existing in a reality space, with reference to a value detected by a first sensor; a second detecting means for detecting the object with reference to a result of previous detection of the object; and an integrating means for detecting the object by integrating a result of detection by the first detecting means and a result of detection by the second detecting means.

### Advantageous Effects of Invention

According to an example aspect of the present invention, it is possible to provide a technique of improving accuracy of detection of an object existing in a reality space.

### BRIEF DESCRIPTION OF DRAWINGS

FIG. 1 is a block diagram illustrating a configuration of a detection system according to a first example embodiment of the present invention.

FIG. 2 is a flowchart illustrating a flow of a detection method according to the first example embodiment of the present invention.

FIG. 3 is a block diagram illustrating a configuration of a detection system according to a second example embodiment of the present invention.

FIG. 4 is a schematic view illustrating an example of an appearance of a user terminal according to the second example embodiment of the present invention.

FIG. 5 illustrates an example of a data structure of object information according to the second example embodiment of the present invention.

FIG. 6 schematically illustrates input and output between functional blocks included in the second example embodiment of the present invention.

FIG. 7 is a flowchart illustrating a flow of a detection method carried out by the user terminal according to the second example embodiment of the present invention.

FIG. 8 is a flowchart illustrating a flow of a detection method carried out by a server according to the second example embodiment of the present invention.

FIG. 9 schematically illustrates a reality space in a first specific example according to the second example embodiment of the present invention.

FIG. 10 illustrates an example of new object information in the first specific example according to the second example embodiment of the present invention.

FIG. 11 schematically illustrates the reality space in a second specific example according to the second example embodiment of the present invention.

FIG. 12 is a schematic view illustrating a first area in the second specific example according to the second example embodiment of the present invention.

FIG. 13 is a schematic view illustrating a second area in the second specific example according to the second example embodiment of the present invention.

FIG. 14 is a schematic view illustrating a coordinate converting process in the second specific example according to the second example embodiment of the present invention.

FIG. 15 is another schematic view illustrating the coordinate converting process in the second specific example according to the second example embodiment of the present invention.

FIG. 16 is a schematic view illustrating IoU in the second specific example according to the second example embodiment of the present invention.

FIG. 17 illustrates an example of updated object information in a third specific example according to the second example embodiment of the present invention.

FIG. 18 is a block diagram illustrating a configuration of a detection system according to a third example embodiment of the present invention.

FIG. 19 is a block diagram illustrating a configuration of a detection system according to a fourth example embodiment of the present invention.

FIG. 20 is a block diagram illustrating a configuration of a detection system according to a fifth example embodiment of the present invention.

FIG. 21 is a block diagram illustrating an example of a hardware configuration of the detection systems according to the example embodiments of the present invention.

### DESCRIPTION OF EMBODIMENTS

### First Example Embodiment

The following description will discuss, in detail, a first example embodiment of the present invention with reference to drawings. The first example embodiment is made the basis of example embodiments described later.

<Configuration of Detection System>

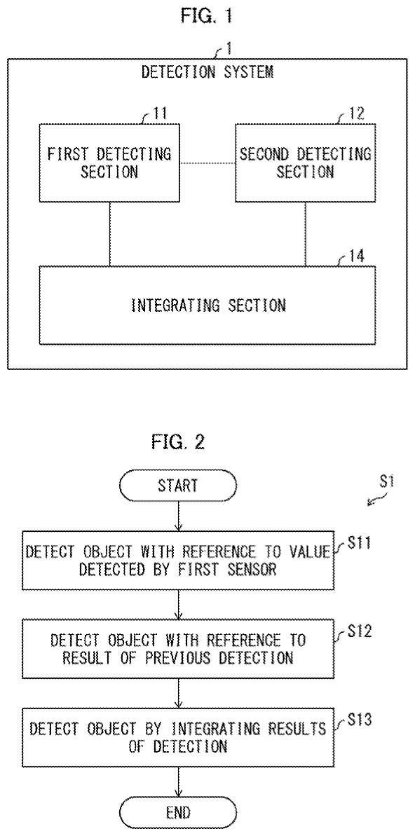

A configuration of a detection system 1 according to the first example embodiment is described with reference to FIG. 1. FIG. 1 is a block diagram illustrating the configuration of the detection system 1.

As illustrated in FIG. 1, the detection system 1 includes a first detecting section 11, a second detecting section 12, and an integrating section 14. Note, here, that the first detecting section 11 is an example of a configuration that realizes a first detecting means recited in the claims. Note also that the second detecting section 12 is an example of a configuration that realizes a second detecting means recited in the claims. Note also that the integrating section 14 is an example of a configuration that realizes an integrating means recited in the claims.

The first detecting section 11 detects an object with reference to a value detected by a first sensor. The first sensor is for detecting the object existing in a reality space. Examples of the first sensor include, but are not limited to, cameras and laser scanners. The first detecting section 11 is connected to the first sensor in such a manner as to be able to obtain the value detected by the first sensor. The first detecting section 11 and the first sensor may be connected to each other by wire or wireless.

Note that the expression “detects an object” includes detecting at least a position of the object. The position to be detected may be a three-dimensional position in a three-dimensional space in which the object exists or may be alternatively a two-dimensional position in a two-dimensional plane on which the three-dimensional space is projected. Note that the expression “position of the object” may be expressed as “three-dimensional or two-dimensional area in which the object is included”. Moreover, the expression “detects an object” may further include detecting an attribute or a feature of the object, such as identification information, a type, a color, a shape, or the like of the object.

The second detecting section 12 detects the object with reference to a result of previous detection of the object. The result of the previous detection of the object is a result obtained by the detection system 1 previously detecting the object, and is, for example, a result of detection by the integrating section 14 (described later). Information indicating the result of the previous detection is accumulated in a storage apparatus. The second detecting section 12 is connected to the storage apparatus in such a manner as to be able to obtain the information indicating the result of the previous detection.

The integrating section 14 detects the object by integrating a result of detection by the first detecting section 11 and a result of detection by the second detecting section 12. For example, in a case where each of the first detecting section 11 and the second detecting section 12 outputs a degree of confidence in the result of the detection, the integrating section 14 integrates the result of the detection by the first detecting section 11 and the result of the detection by the second detecting section 12 on the basis of these degrees of confidence.

Note, here, that integrating such two detection results indicates determining a detection result with reference to each of the two detection results. For example, integrating two detection results may be determining which one of the two detection results is employed, on the basis of each of the two detection results. Alternatively, integrating two detection results may be determining whether or not one of the two detection results is employed, on the basis of the other of the two detection results. Integrating two detection results may include calculating a new degree of confidence with reference to a degree of confidence in each of the two detection results.

<Flow of Detection Method>

A flow of a detection method S1 carried out by the detection system 1 configured as described above is described with reference to FIG. 2. FIG. 2 is a flowchart illustrating the flow of the detection method S1.

(Step S11)

In a step S11, the first detecting section 11 detects an object with reference to a value detected by a first sensor.

(Step S12)

In a step S12, the second detecting section 12 detects the object with reference to a result of previous detection of the object.

(Step S13)

In a step S13, the integrating section 14 detects the object by integrating a result of detection by the first detecting section 11 and a result of detection by the second detecting section 12.

### Effect of the First Example Embodiment

In the first example embodiment, an object is detected by integrating (i) a result of detection of the object which detection has been carried out with reference to a value detected by a first sensor and (ii) a result of detection of the object which detection has been carried out with reference to a result of previous detection. This makes it possible to detect the object more accurately, as compared with a case where only the first detecting section 11 or the second detecting section 12 is used.

### Second Example Embodiment

The following description will discuss, in detail, a second example embodiment of the present invention with reference to drawings. Note that elements having the same functions as those of the elements described in the first example embodiment are denoted by the same reference numerals, and descriptions thereof will not be repeated.

<Configuration of Detection System>

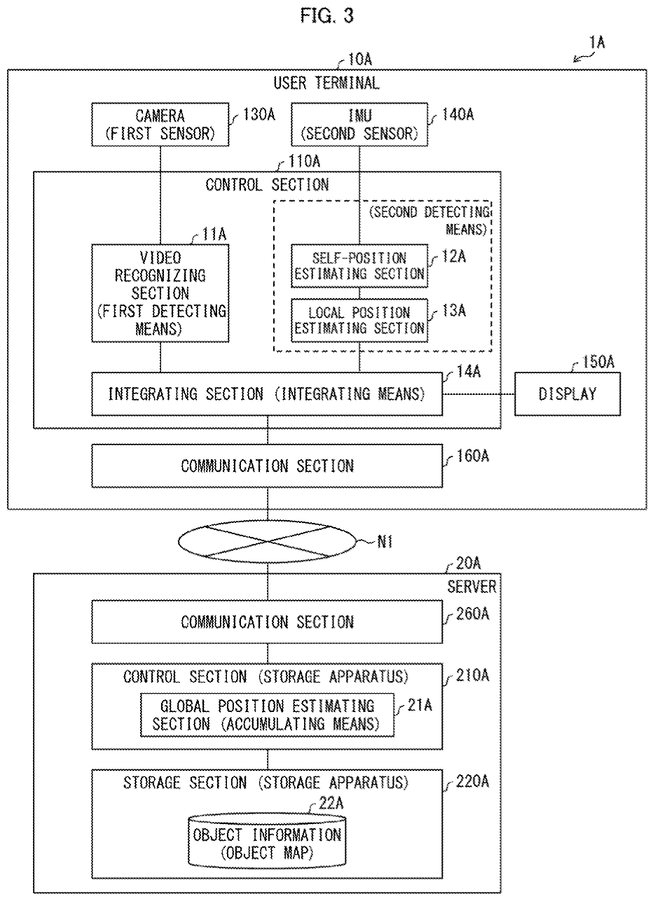

A configuration of a detection system TA according to the second example embodiment is described with reference to FIG. 3. FIG. 3 is a block diagram illustrating the configuration of the detection system TA.

As illustrated in FIG. 3, the detection system TA includes a user terminal 10A and a server 20A. The user terminal 10A and the server 20A are connected to each other via a network N1. The network N1 is, for example, a wireless local area network (LAN), a wired LAN, a wide area network (WAN), a public network, a mobile data communication network, or a combination of these networks. Note, however, that a configuration of the network N1 is not limited to these examples. Note also that, although FIG. 1 illustrates a single user terminal 10A and a single server 20A, the numbers of apparatuses included in the detection system TA are not limited.

(Configuration of User Terminal)

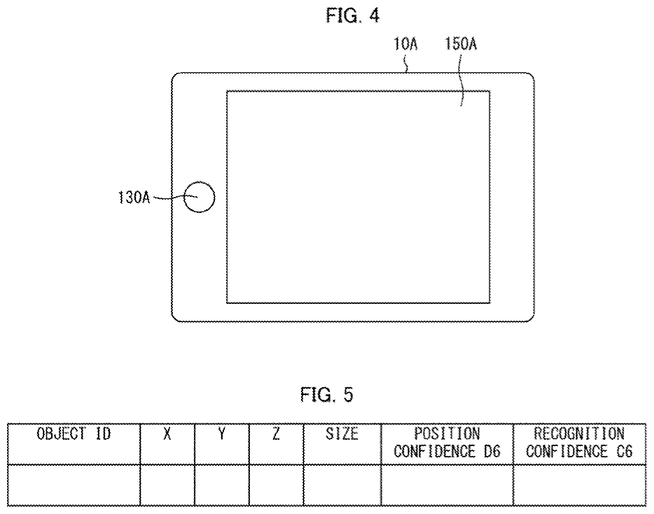

A configuration of the user terminal 10A is described with reference to FIGS. 3 and 4. FIG. 4 is a schematic view illustrating an example of an appearance of the user terminal 10A. As illustrated in FIGS. 3 and 4, the user terminal 10A includes a control section 110A, a camera 130A, an inertial measurement unit (IMU) 1140A, a display 150A, and a communication section 160A. The control section 110A includes a video recognizing section 11A, a self-position estimating section 12A, a local position estimating section 13A, and an integrating section 14A. The user terminal 10A is, for example, a tablet terminal or a smartphone of which an appearance is as illustrated in FIG. 4, but is not limited to these examples.

Note, here, that the camera 130A is an example of a first sensor recited in the claims. The IMU 140A is an example of a second sensor recited in the claims. The video recognizing section 11A is an example of the configuration that realizes the first detecting means recited in the claims. The self-position estimating section 12A and the local position estimating section 13A are an example of the configuration that realizes the second detecting means recited in the claims. The integrating section 14A is an example of the configuration that realizes the integrating means recited in the claims.

(Camera)

The camera 130A captures an image of an environment around the camera 130A, and generates a captured image. The camera 130A generates the captured image, for example, by (i) converting light entering through a condensing lens into an electrical signal with use of an imaging element, (ii) carrying out A/D conversion with respect to the electrical signal, and (iii) carrying out image processing. The imaging element is, for example, a charge coupled device (CCD), a complementary metal oxide semiconductor (CMOS), or the like, but is not limited to these examples. The camera 130A outputs the captured image to the control section 110A. The camera 130A generates captured images at a given frame rate. Hereinafter, the captured image is also referred to as “video frame”.

(IMU)

The IMU 140A is an apparatus which detects angular velocities and accelerations in three axial directions that are perpendicular to each other. The IMU 140A includes a gyro sensor and an acceleration sensor. The gyro sensor detects the angular velocities, and the acceleration sensor detects the accelerations. The IMU 140A outputs detected a value to the control section 110A.

(Display)

The display 150A displays an image outputted from the control section 110A. The display 150A is, for example, a liquid crystal display, a plasma display, an inorganic electro luminescence (EL) display, or an organic EL display, but is not limited to these examples. The display 150A may be integrally formed together with a touch panel.

(Communication Section)

The communication section 160A communicates with the server 20A in accordance with control by the control section 110A. Hereinafter, that the control section 110A controls the communication section 160A to transmit and receive data is also referred to as “the control section 110A transmits and receives data”.

A detailed configuration of the control section 110A is described later.

(Configuration of Server 20A)

As illustrated in FIG. 3, the server 20A includes a control section 210A, a storage section 220A, and a communication section 260A. The control section 210A includes a global position estimating section 21A. In the storage section 220A, object information 22A is stored. The object information 22A indicates a result of previous detection of an object. The object information 22A is stored in a database for each previously detected object. Hereinafter, the database in which the object information 22A pertaining to each object is stored is also referred to as “object map”. Details of the object map are described later. The global position estimating section 21A is an example of a configuration that realizes an accumulating means recited in the claims. The communication section 260A communicates with the user terminal 10A in accordance with control by the control section 210A. Hereinafter, that the control section 210A controls the communication section 260A to transmit and receive data is also referred to as “the control section 210A transmits and receives data”.

(Object Map)

The object map is a database in which the object information 22A is stored for each of one or more objects. The object information 22A indicates a result of previous detection of the each of the one or more objects. The object information 22A is accumulated in the object map in a case where the each of the one or more objects is detected. Hereinafter, the object information 22A stored in the object map is also referred to as “accumulated object information 22A”.

A data structure of the object information 22A is described with reference to FIG. 5. FIG. 5 illustrates the data structure of the object information 22A. As illustrated in FIG. 5, the object information 22A includes an object ID, coordinates (x, y, z), a size, position confidence D6, and recognition confidence C6.

The object ID is identification information that identifies an object uniquely. The coordinates (x, y, z) are global coordinates indicating a global position of the object, and are, for example, coordinates of a center of the object. The size is information indicating a size of the object. For easiness, description here is provided on an assumption that a shape of the object is defined by a regular hexahedron. In this case, the size is indicated by a length of a side of the regular hexahedron. In the second example embodiment, the size of the object is given in advance in accordance with the object ID. Note that the size of the object is not limited to the length of the side of the regular hexahedron. Note also that the size of the object is not limited to a condition that the size of the object is given in advance. For example, the global position estimating section 21A may detect the size of the object, and include the size in the object information 22A. The recognition confidence C6 is a degree of confidence that is in a result of previous detection indicated by the object information 22A and that relates to recognition. The position confidence D6 is a degree of confidence that is in the result of the previous detection indicated by the object information 22A and that relates to the position.

(Detailed Configuration of Control Section)

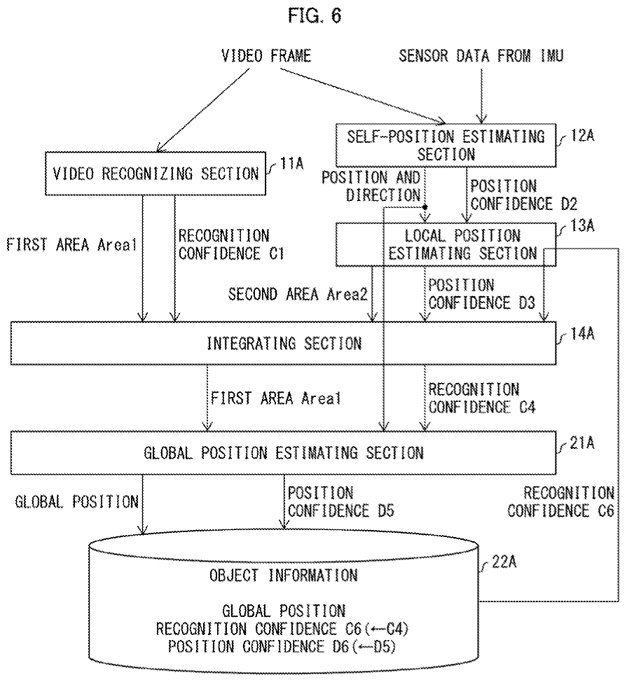

Next, detailed configurations of the sections included in the control section 110A of the user terminal 10 and the control section 210A of the server 20 are described with reference to FIG. 6. FIG. 6 schematically illustrates input and output between functional blocks included in the detection system 1A.

(Recognition Confidence and Position Confidence)

As illustrated in FIG. 6, the input and the output between the functional blocks include recognition confidence and position confidence. The recognition confidence is a degree of confidence relating to recognition of an object. The position confidence is a degree of confidence relating to a detected position of the object or a degree of confidence relating to a detected position and a detected direction of the user terminal 10A. These degrees of confidence each take a value of 0 or more and 1 or less.

(Video Recognizing Section)

The video recognizing section 11A detects the object with reference to a video frame captured by the camera 130A. Specifically, the video recognizing section 11A detects the object by specifying an area of the object in the video frame obtained from the camera 130A. Hereinafter, the area of the object which area is specified by the video recognizing section 11A is referred to as a first area. The first area indicates a two-dimensional position of the object in the video frame. The video recognizing section 11A obtains the video frame as input, and outputs recognition confidence C1 and information indicating the first area. The first area is represented by, for example, a bounding box or segment information, but is not limited to these examples. Note that the segment information is information indicating one or more segments that constitute the first area, out of a plurality of segments into which the video frame is divided.

The recognition confidence C1 is a degree of confidence that is in a result of detection by the video recognizing section 11A and that relates to recognition. For example, as the recognition confidence C1, a degree of confidence that is outputted by a video recognition technique employed by the video recognizing section 11A is used.

Specifically, the video recognizing section 11A detects the object with use of a detection model that has been trained so as to detect the first area from the video frame. For example, the video frame is inputted into the detection model, and then the detection model outputs an object ID of the object that has been detected, the information indicating the first area of the object that has been detected, and the recognition confidence C1 of the object that has been detected. Such a detection model can be generated with use of, as training data, data in which a video frame obtained by capturing an image of an object that is a target of recognition is associated with a correct first area. For example, the training data is generated by a user capturing the image of the object with use of the camera 130A and inputting, as the correct first area, a first area that is in the captured video frame and that includes the object. A machine learning algorithm used to generate the detection model is, for example, deep learning such as You Only Look Once (YOLO), but is not limited to this example.

Alternatively, the video recognizing section 11A may detect the first area with use of a feature matching process, instead of the detect model. The feature matching process is a process of matching a preregistered feature of an image of the object and a feature extracted from the video frame. Examples of a technique of extracting the feature include, but are not limited to, scale-invariant feature transform (SIFT) and speed-up robust features (SURF).

Note that the video recognizing section 11A is not limited to a method in which the detection model is used or a method in which the feature matching process is used, and can detect the first area with use of another known technique of detecting the object from the video frame. Note, however, that in a case where the second example embodiment is used for AR, it is required to reduce a delay in a process from when the video frame is obtained to when the video frame on which virtual information based on the recognized object is superimposed is displayed. Therefore, in this case, it is desirable that the video recognition technique employed by the video recognizing section 11A be a technique that operates quickly.

Note also that it is assumed that, in the second example embodiment, the detection model has already been trained in advance. Note, however, that generation of the detection model may be carried out sequentially. For example, the video recognizing section 11A may additionally train the detection model, with use of a video frame for which the detection system 1A determined that the object was unable to be detected. For example, the video recognizing section 11A specifies a correct first area in the video frame with reference to, for example, an input from the user. The video recognizing section 11A additionally trains the detection model with use of training data in which the video frame and the correct first area are associated with each other.

Note also that, in the second example embodiment, the description is provided on an assumption that the video recognizing section 11A includes the detection model (i.e., the detection model is stored in the user terminal 10A). However, the detection model may be stored in the server 20A. Note also that the detection model is not limited to a detection model generated by the user terminal 10A, and may be generated by the server 20 or an apparatus external to the detection system 1A.

(Self-Position Estimating Section)

The self-position estimating section 12A estimates a position and a direction of the user terminal 10A in a reality space with reference to sensor data obtained from the IMU 140A and the video frame obtained from the camera 130A. Specifically, the self-position estimating section 12A outputs (i) information indicating the position and the direction of the user terminal 10A and (ii) position confidence D2 indicating a degree of confidence in a result of estimation. A known estimation technique can be employed as a technique of estimating the position and the direction with reference to the sensor data and the video frame. Note that, in a case where the estimation technique employed outputs a probability distribution or a shared variance of the position and the direction, the self-position estimating section 12A may calculate the position confidence D2 from the probability distribution or the shared variance.

(Local Position Estimating Section)

The local position estimating section 13A estimates a relative position of the object as viewed from the user terminal 10A with reference to (i) object information 22A accumulated in the server 20A and (ii) the position and the direction of the user terminal 10A which have been estimated by the self-position estimating section 12A. Hereinafter, the relative position of the object is also referred to as “local position”. Further, the local position estimating section 13A calculates a second area including the object, on the basis of the local position of the object. Further, the local position estimating section 13A outputs information indicating the second area, position confidence D3, and recognition confidence C6. The position confidence D3 is a degree of confidence relating to a position of the second area. The recognition confidence C6 is included in the object information 22A that has been referred to in order to calculate the second area.

Note, here, that the local position of the object is a position of the object in a field-of-view image. The second area is specified as a two-dimensional area in the field-of-view image. For example, the second area is represented by a bounding box or segment information in the field-of-view image. Note that the field-of-view image is a two-dimensional image on which the reality space as viewed from the position of the user terminal 10A is projected. In other words, the field-of-view image can be captured by the camera 130A provided to the user terminal 10A, and displayed as a screen by the display 150A. Hereinafter, a two-dimensional coordinate system set on the field-of-view image is also referred to as a screen coordinate system.

The local position estimating section 13A calculates the position confidence D3 on the basis of (i) the position confidence D2 outputted by the self-position estimating section 12A and (ii) position confidence D6. The position confidence D6 is included in the object information 22A that has been referred to in order to calculate the second area. For example, the position confidence D3 is calculated by the following expression (1).

D3=D2×D6 (1)

By thus multiplying the position confidence D2 and the position confidence D6 together, uncertainty relating to the estimation of the position and the direction of the user terminal 10A and uncertainty relating to a previous position of the object are additively taken into consideration. In other words, the local position estimating section 13A calculates the position confidence D3 that becomes higher as at least one of the position confidence D2 and the position confidence D6 becomes higher. Note that the position confidence D3 is not limited to the expression (1), and may be calculated by another calculation method, provided that the uncertainty relating to the estimation of the position and the direction of the user terminal 10A and the uncertainty relating to the previous position of the object are taken into consideration additively or in such a manner as to be increased.

(Integrating Section)

The integrating section 14A detects the object by integrating the result of the detection by the video recognizing section 11A and a result of detection by the local position estimating section 13A. Specifically, the integrating section 14A integrates the result of the detection by the video recognizing section 11A and the result of the detection by the local position estimating section 13A with reference to the recognition confidence C1, the position confidence D3, and the recognition confidence C6. Note that the integrating section 14A manages a result of detection obtained by integration, for each of objects that differ in object ID. Details of an integrating process are described later.

The integrating section 14A may cause the display 150A to display information indicating a result of detection obtained by integration. For example, the integrating section 14A superimposes, on the video frame, virtual information based on the result of the detection obtained by the integration, and causes the display 150A to display the superimposed image.

(Details of Integrating Process)

The integrating section 14A calculates recognition confidence C4 with reference to (i) the recognition confidence C1 outputted by the video recognizing section 11A and (ii) the recognition confidence C6 outputted by the local position estimating section 13A. In a case where the calculated recognition confidence C4 is equal to or higher than a threshold, the integrating section 14A employs the result of the detection by the video recognizing section 11A, and sets this result as the result of the detection by the integrating section 14A. In a case where the calculated recognition confidence C4 is less than the threshold, the integrating section 14A outputs the result of the detection which result indicates that the object has been unable to be detected.

(Process of Calculating Recognition Confidence C4)

Details of the process of calculating the recognition confidence C4 are described. First, the integrating section 14A determines whether or not to refer to the recognition confidence C6 outputted by the local position estimating section 13A, in order to calculate the recognition confidence C4. Specifically, the integrating section 14A determines whether or not to refer to the recognition confidence C6, on the basis of (i) whether or not the position confidence D3 calculated by the local position estimating section 13A is less than a threshold and (ii) whether or not a relationship between the position of the object which position has been detected by the video recognizing section 11A and the position of the object which position has been detected by the local position estimating section 13A satisfies a condition.

Note, here, that, as the condition, for example, a condition that IoU, which indicates a degree of overlap between the first area and the second area, is equal to or higher than a threshold is applied. For example, in a case where the IoU is equal to or higher than the threshold, the integrating section 14A determines to refer to the recognition confidence C6. Note, however, that the condition is not limited to the example described above. For example, as the condition, a condition that a distance between a center point of the first area and a center point of the second area is equal to or less than a threshold may be applied.

In a case where the integrating section 14A determines to refer to the recognition confidence C6, the integrating section 14A calculates the recognition confidence C4 so that the recognition confidence C4 satisfies the following expression (2).

C4≥max(C1,C6) (2)

That is, the integrating section 14A calculates, as the recognition confidence C4, a value that is equal to or higher than higher one of values of the recognition confidence C1 and the recognition confidence C6. In other words, the integrating section 14A calculates the recognition confidence C4 that becomes higher as at least one of the recognition confidence C1 and the recognition confidence C6 becomes higher. This is because, in a case where two different object detecting mechanisms (i.e., the video recognizing section 11A and the local position estimating section 13A) output similar positions, it is desirable to increase recognition confidence so that a degree of confidence in recognition by each of the object detecting mechanisms increases. Note that the recognition confidence C4 is not limited to the expression (2), and may be calculated by another calculation method.

In a case where the relationship between the position of the object which position has been detected by the video recognizing section 11A and the position of the object which position has been detected by the local position estimating section 13A does not satisfy the condition, the integrating section 14A considers that the previously detected object has moved. In this case, the integrating section 14A determines not to refer to the recognition confidence C6 which is a degree of confidence that is in the result of the previous detection and that relates to recognition. This makes it possible to accurately detect a moving object without referring to a result of previous detection.

(Multimodal Detecting Mechanism)

In other words, in a case where the recognition confidence C1 calculated by the video recognizing section 11A is lower than the threshold, the integrating section 14A ignores the recognition confidence C1, as described above. In a case where the position confidence D3 or the recognition confidence C6 outputted by the local position estimating section 13A is lower than the threshold, the integrating section 14A ignores the position confidence D3 or the recognition confidence C6. That is, the integrating section 14A operates as a multimodal detecting mechanism that integrates the result of the detection by the video recognizing section 11A and the result of the detection by the local position estimating section 13A. The integrating section 14A also operates as a single-modal detecting mechanism, depending on the degree of confidence in each of the results of the detection.

(Global Position Estimating Section)

The global position estimating section 21A accumulates, in the object map, the object information 22A indicating the result of the previous detection of the object, on the basis of the result of the detection by the integrating section 14A. Note, here, that the expression “accumulates the object information 22A” includes (i) registering new object information 22A in the object map, (ii) updating existing object information 22A, and (iii) deleting the existing object information 22A.

Specifically, the global position estimating section 21A estimates a position of the object in the reality space with reference to the result of the detection by the integrating section 14A, includes the estimated position into the object information 22A, and accumulates the object information 22A in the object map. The position in the reality space is represented by, for example, a global coordinate system. Hereinafter, the position in the reality space is also referred to as “global position”. For example, the global position estimating section 21A estimates the global position on the basis of (i) the result of the detection by the integrating section 14A and (ii) the position and the direction of the user terminal 10A that have been estimated by the self-position estimating section 12A. The global position estimating section 21A may further refer to a size of the object which size is included in the object information 22A, in order to estimate the global position. Further, the global position estimating section 21A calculates, together with the global position, position confidence D5 that is a degree of confidence in the global position. The global position estimating section 21A can employ, for example, a known estimation technique in which various pieces of sensor data are used to estimate a global position. Specific examples of the estimation technique include simultaneous localization and mapping (SLAM). The SLAM is a technique of simultaneously estimating a self-position of a terminal and constructing a map of an object around the terminal. With use of the SLAM, the global position estimating section 21A can calculate the global position of the object and the position confidence D5 from the result of the detection by the integrating section 14A.

The global position estimating section 21A determines whether or not to accumulate, in the object map, the object information 22A pertaining to the detected object, with reference to the calculated position confidence D5 and the recognition confidence C4 received from the integrating section 14A.

Specifically, in a case where the object information 22A which includes the same ID as that of the detected object is not accumulated in the object map, the global position estimating section 21A determines whether or not to register the object information 22A, on the basis of the recognition confidence C4. In a case where the recognition confidence C4 is equal to or lower than the threshold, the global position estimating section 21A does not register the object information 22A. In a case where the recognition confidence C4 is equal to or higher than the threshold, the global position estimating section 21A registers the object information 22A. The object information 22A to be registered includes the object ID, the global position, the position confidence D6, and the recognition confidence C6. As the recognition confidence C6 included in the object information 22A to be registered, the value of the recognition confidence C4 received from the integrating section 14A is applied. As the position confidence D6 included in the object information 22A to be registered, a value of the position confidence D5 calculated with regard to the global position is applied.

In a case where the object information 22A which includes the same ID as that of the detected object is accumulated in the object map, the global position estimating section 21A determines whether or not to update the object information 22A, on the basis of a confidence score. The confidence score is an index calculated on the basis of the recognition confidence and the position confidence. The confidence score increases with an increase in at least one of the recognition confidence C4 and the position confidence D5. For example, the confidence score is a sum or a product of the recognition confidence and the position confidence. Note, however, that a method for calculating the confidence score is not limited to the above-described calculation method.

Specifically, the global position estimating section 21A calculates a confidence score Score1 on the basis of the recognition confidence C4 and the position confidence D5. Further, the global position estimating section 21A calculates a confidence score Score2 on the basis of the recognition confidence C6 and the position confidence D6 that are included in the object information 22A. The confidence score Score2 is an example of a “previous confidence score” recited in the claims. In a case where the confidence score Score1 is higher than the previous confidence score Score2, the global position estimating section 21A determines to update the object information 22A.

<Flow of Detection Method>

The detection system 1A configured as described above carries out a detection method S1A. The detection method S1A includes a detection method S10A that is carried out by the user terminal 10A and a detection method S20A that is carried out by the server 20A.

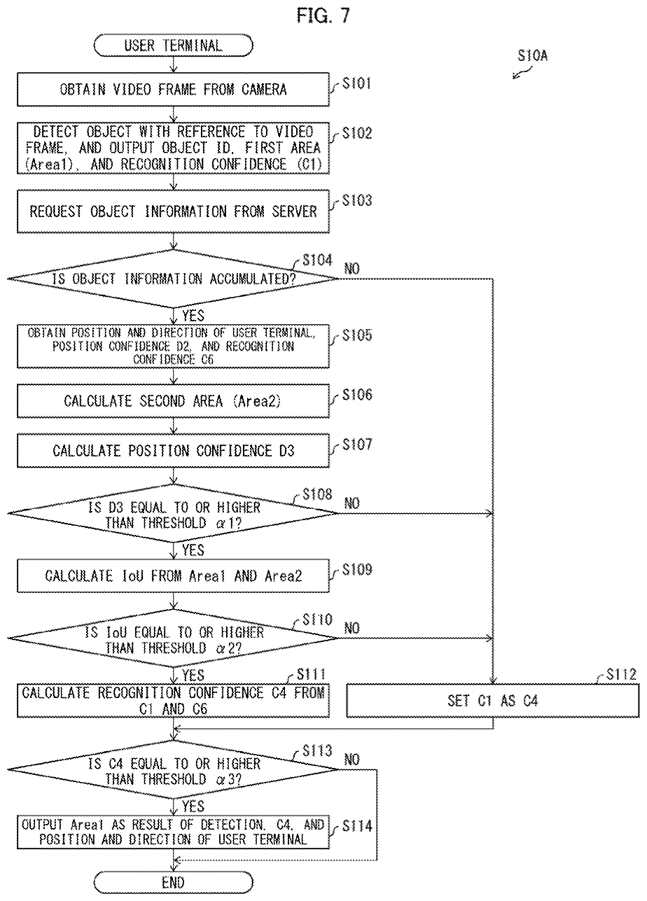

(Flow of detection method carried out by user terminal) First, a flow of the detection method S10A carried out by the user terminal 10A is described with reference to FIG. 7. FIG. 7 is a flowchart illustrating the flow of the detection method S10A. As illustrated in FIG. 7, the detection method S10A includes steps S101 to S114.

(Step S101)

In the step S101, the video recognizing section 11A obtains a video frame from the camera 130A.

(Step S102)

In the step S102, the video recognizing section 11A detects an object from the video frame. For example, the video recognizing section 11A inputs the obtained video frame into a detection model, and obtains (i) an object ID, (ii) a first area Area1 that includes the object, and (iii) recognition confidence C1, which are outputted from the detection model.

(Step S103)

In the step S103, the local position estimating section 13A requests, from the server 20A, object information 22A pertaining to the object detected in the step S102.

With reference to the received object information 22A, the local position estimating section 13A calculates an area which is in a global coordinate system and in which the object has been previously detected. Hereinafter, the area is also referred to as “previous area”. For example, the local position estimating section 13A calculates, as the previous area, an area of a regular hexahedron of which a center corresponds to coordinates of a center, i.e., a global position, of the object and of which a side corresponds to a size of the object.

Note that this step of receiving the object information 22A can be carried out at any point in time. For example, the local position estimating section 13A may receive object information 22A pertaining to each object that is a target of recognition, by periodically requesting, from the server 20A, the object information 22A. Alternatively, the server 20A may transmit the object information 22A to the user terminal 10A in response to update of the object information 22A.

(Step S104)

In the step S104, the local position estimating section 13A determines whether or not the local position estimating section 13A has been able to obtain the object information 22A in the step S103. In other words, the local position estimating section 13A determines whether or not corresponding object information 22A is accumulated in the object map.

(“YES” in Step S104: Step S105)

In a case where a determination is made as “YES” in the step S104, the self-position estimating section 12A estimates, in the step S105, a position and a direction of the user terminal 10A with reference to (i) the video frame obtained in the step S101 and (ii) sensor data from the IMU 140A. Further, the self-position estimating section 12A calculates position confidence D2 that is a degree of confidence in a result of estimation. Further, the self-position estimating section 12A obtains recognition confidence C6 included in the object information 22A.

(Step S106)

In the step S106, the local position estimating section 13A determines a second area Area2 with use of the object information 22A and information pertaining to the position and the direction of the user terminal 10A. Information indicating the second area Area2 is represented by a screen coordinate system.

(Step S107)

In the step S107, the local position estimating section 13A calculates position confidence D3 with reference to (i) position confidence D6 included in the object information 22A and (ii) the position confidence D2 calculated by the self-position estimating section 12A. Further, the local position estimating section 13A outputs the recognition confidence C6 included in the object information 22A.

(Step 108)

In the step S108, the local position estimating section 13A determines whether or not the position confidence D3 is equal to or higher than a threshold α1. The threshold α1 is a threshold for determining whether or not to refer to the recognition confidence C6.

(“YES” in Step S108: Step S109)

In a case where a determination is made as “YES” in the step S108, the integrating section 14A calculates, in the step S109, IoU that indicates a degree of overlap between the first area Area1 and the second area Area2.

(Step S110)

In the step S110, the integrating section 14A determines whether or not the IoU is equal to or higher than a threshold α2. The threshold α2 is a threshold for determining whether or not to refer to the recognition confidence C6.

(“YES” in Step S110: Step S111)

In a case where a determination is made as “YES” in the step S110, the integrating section 14A calculates, in the step S111, recognition confidence C4 with reference to (i) the recognition confidence C1 calculated by the video recognizing section 11A and (ii) the recognition confidence C6 outputted by the local position estimating section 13A. For example, the recognition confidence C4 is calculated by the above-described expression (2).

(Step S113)

In the step S113, the integrating section 14A determines whether or not the recognition confidence C4 is equal to or higher than a threshold α3. The threshold α3 is a threshold for determining whether or not to employ a result of detection by the video recognizing section 11A.

(“YES” in Step S113: Step S114)

In a case where a determination is made as “YES” in the step S113, the integrating section 14A outputs, in the step S114, information indicating the object ID and the first area Area1 that are the result of the detection by the video recognizing section 11A, as a result of detection obtained by integration. Further, the integrating section 14A outputs the recognition confidence C4 as a degree of confidence that is in the result of the detection obtained by the integration and that relates to recognition. Further, the integrating section 14A outputs the position and the direction of the user terminal 10A that have been estimated by the self-position estimating section 12A. Specifically, the integrating section 14A transmits, to the server 20A, the result of the detection, the recognition confidence C4, and the position and the direction of the user terminal 10A.

(“NO” in Step S104, S108, S110: Step S112)

In a case where a determination is made as “NO” in the step S104, S108, or S110, the integrating section 14A sets, in the step S112, the recognition confidence C1, which has been calculated by the video recognizing section 11A, as the recognition confidence C4. Subsequently, the user terminal 10A carries out the steps S113 and S114. Thus, in a case where the degree of confidence in recognition by the video recognizing section 11A (the recognition confidence C1, i.e., the recognition confidence C4 in this case) is equal to or higher than the threshold α3, the result of the detection by the video recognizing section 11A (the object ID and the first area Area1) is outputted as the result of the detection obtained by the integration.

(“NO” in Step S113)

In a case where a determination is made as “NO” in the step S113, the user terminal 10A ends the detection method S10A. In this case, for example, the detection system 1A may output a result of detection which result indicates that the object has been unable to be detected.

(Flow of Detection Method Carried Out by Server)

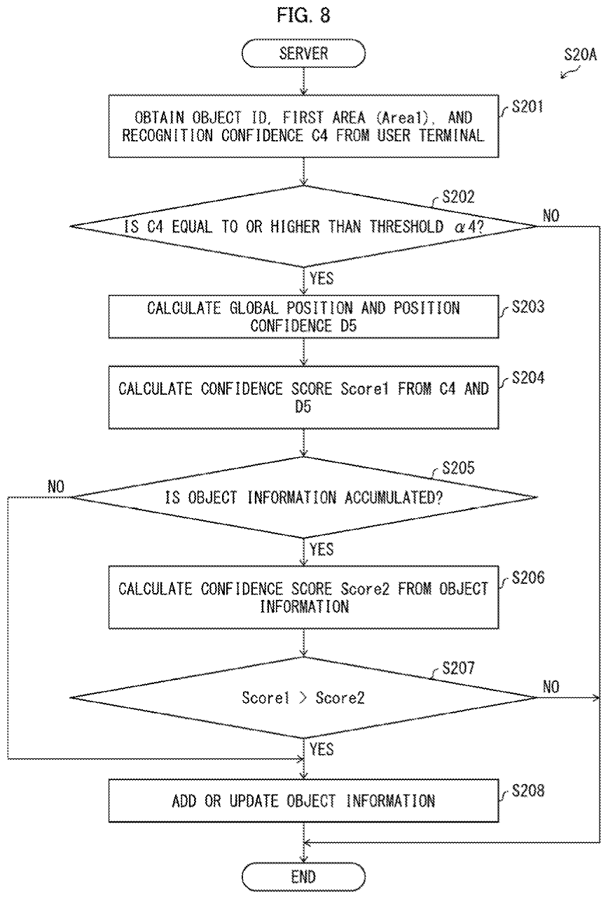

Next, a flow of the detection method S20A carried out by the server 20A is described with reference to FIG. 8. FIG. 8 is a flowchart illustrating the flow of the detection method S20A. As illustrated in FIG. 8, the detection method S20A includes steps S201 to S208.

(Step S201)

In the step S201, the global position estimating section 21A of the server 20A obtains, from the user terminal 10A, (i) the result of the detection by the integrating section 14A (the information indicating the object ID and the first area Area1) and (ii) the recognition confidence C4.

(Step S202)

In the step S202, the global position estimating section 21A determines whether or not the recognition confidence C4 is equal to or higher than a threshold α4. The threshold α4 is a threshold for determining whether or not to accumulate the object information 22A.

(“YES” in Step S202: Step S203)

In a case where a determination is made as “YES” in the step S202, the global position estimating section 21A estimates, in the step S203, a global position of the object with reference to (i) the result of the detection by the integrating section 14A and (ii) the position and the direction of the user terminal 10A. Further, the global position estimating section 21A calculates position confidence D5 in a result of estimation.

(Step S204)

In the step S204, the global position estimating section 21A calculates a confidence score Score1 on the basis of the position confidence D5 and the recognition confidence C4 that has been obtained from the user terminal 10A. Note, here, that the confidence score Score1 is a sum of the recognition confidence C4 and the position confidence D5.

(Step S205)

In the step S205, the global position estimating section 21A determines whether or not the object information 22A of the object ID is accumulated in the object map.

(“YES” in Step S205: Step S206)

In a case where a determination is made as “YES” in the step S205, the global position estimating section 21A obtains, in the step S206, the object information 22A from the object map. Further, the global position estimating section 21A calculates a confidence score Score2 on the basis of the position confidence D6 and the recognition confidence C6 that are included in the object information 22A. Note, here, that the confidence score Score2 is a sum of the recognition confidence C6 and the position confidence D6.

(Step S207)

In the step S207, the global position estimating section 21A determines whether or not the confidence score Score1 is higher than the confidence score Score2.

(“YES” in Step S207: Step S208)

In a case where a determination is made as “YES” in the step S207, the global position estimating section 21A accumulates the object information 22A in the object map. Specifically, the global position estimating section 21A updates, to the global position calculated in the step S203, a global position included in the object information 22A that is of the object ID and that is already stored. The global position estimating section 21A also updates, to a value of the position confidence D5, the position confidence D6 included in the object information 22A. The global position estimating section 21A also updates, to a value of the recognition confidence C4, the recognition confidence C6 included in the object information 22A.

(“NO” in Step S205: Step S208)

In a case where a determination is made as “NO” in the step S205, the global position estimating section 21A carries out the step S208. That is, in this case, the global position estimating section 21A newly adds, to the object map, the object information 22A of the object ID. The newly added object information 22A includes the object ID that has been received from the user terminal 10A and the global position that has been calculated in the step S203. Further, the newly added object information 22A includes, as the position confidence D6, the value of the position confidence D5 calculated in the step S203. The newly added object information 22A also includes, as the recognition confidence C6, the value of the recognition confidence C4 received from the user terminal 10A.

(“NO” in Steps S202 and S207)

In a case where a determination is made as “NO” in the step S202 or S207, the server 20A ends the detection method S20A.

### SPECIFIC EXAMPLES

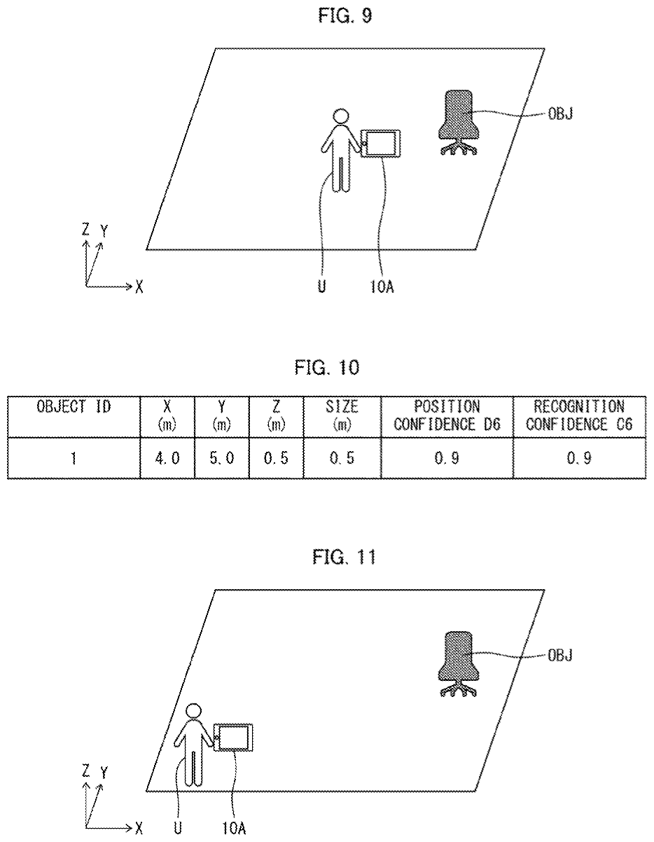

Specific examples of the detection method S1A carried out by the detection system 1A is described with reference to FIGS. 9 to 16. Here described are a first specific example in which the detection system 1A detects an object OBJ for the first time and second and third specific examples in which the detection system 1A subsequently detects the object OBJ again.

### First Specific Example: Detecting Object OBJ for the First Time

(Specific Example of Step S101)

FIG. 9 schematically illustrates a reality space that is a target of detection in the first specific example. As illustrated in FIG. 9, a global coordinate system (X, Y, Z) is set in the reality space. In the reality space, there exist a user U, the user terminal 10A held by the user U, and the object OBJ. As illustrated in FIG. 9, the user U is sufficiently close to the object OBJ. Note, here, that the expression “sufficiently close” indicates being close to such a degree that the object OBJ can be detected with the recognition confidence C1 equal to or higher than the threshold α3. In this state, the user U directs the camera 130A, which is provided to the user terminal 10A, toward the object OBJ. The camera 130A generates a video frame that includes the object OBJ. The user terminal 10A carries out the step S101 to obtain the video frame.

(Specific Example of Step S102)

The video recognizing section 11A of the user terminal 10A inputs the video frame into the detection model, and then obtains (i) an object ID, which is 1, of the object OBJ and (ii) a first area Area1 that is in the video frame and that includes the object OBJ. It is assumed that, in so doing, the video recognizing section 11A calculates 0.9 as the recognition confidence C1. In this example, the recognition confidence C1, which is 0.9, is equal to or higher than the threshold α3.

(Specific Examples of Steps S103 and S104)

In a case where the object OBJ is detected for the first time, object information 22A pertaining to the object OBJ is not accumulated in the object map at a time when the steps S103 and S104 are carried out. Therefore, the local position estimating section 13A makes a determination as “NO” in the step S104.

(Specific Examples of Steps S112 to S114)

Thus, the integrating section 14A carries out the step S112 to set, as the recognition confidence C4, the recognition confidence C1 calculated by the video recognizing section 11A. That is, the recognition confidence C4 is 0.9. Further, since the recognition confidence C4 is equal to or higher than the threshold α3 (“YES” in the step S113), the integrating section 14A carries out the step S114. That is, the integrating section 14A transmits, to the server 20A, a result of detection by the video recognizing section 11A (the object ID and the first area Area1), the recognition confidence C4, and the position and the direction of the user terminal 10A.

(Specific Examples of Steps S201 to S203)

The global position estimating section 21A of the server 20A receives the result of the detection and the recognition confidence C4 from the user terminal 10A. Since the received recognition confidence C4, which is 0.9, is equal to or higher than the threshold α4, the global position estimating section 21A makes a determination as “YES” in the step S202.

(Specific Example of Step S203)

In the step S203, the global position estimating section 21A estimates a global position of the object OBJ on the basis of (i) the result of the detection received from the user terminal 10A and (ii) the position and the direction of the user terminal 10A. It is assumed, here, that the global position (X=4.0 (m: meter), Y=5.0 (m), Z=0.5 (m)) is estimated. Further, the global position estimating section 21A calculates 0.9 as the position confidence D5 in a result of estimation.

(Specific Example of Step S204)

In the step S204, the global position estimating section 21A calculates, as the confidence score Score1, 1.8 that is a sum of the recognition confidence C4, which is 0.9, and the position confidence D5, which is 0.9.

(Specific Examples of Steps S205 and S208)

In the step S205, the object information 22A pertaining to the object is not yet stored in the object map (“NO” in the step S205). Therefore, the global position estimating section 21A carries out the step S208. That is, the global position estimating section 21A newly adds, to the object map, the object information 22A pertaining to the object OBJ. FIG. 10 illustrates an example of the new object information 22A. As illustrated in FIG. 10, the object information 22A includes the object ID, which is 1, and the global position (X=4.0 (m: meter), Y=5.0 (m), Z=0.5 (m)). Further, the object information 22A includes, as a size, a value that has been given in advance, i.e., 0.5 (m). Further, the object information 22A includes, as the position confidence D6, a value of the position confidence D5, i.e., 0.9. The object information 22A also includes, as the recognition confidence C6, a value of the recognition confidence C4, i.e., 0.9.

### Second Specific Example: Detecting Object OBJ Again

(Specific Example of Step S101)

It is assumed that the user U has subsequently moved farther away from the object OBJ. FIG. 11 schematically illustrates the reality space in a state where the user U is away from the object OBJ. As illustrated in FIG. 11, the user U directs the camera 130A, which is provided to the user terminal 10A, toward the object OBJ in a state where the user U is away from the object OBJ. The camera 130A generates a video frame that includes the object OBJ. The user terminal 10A carries out the step S101 to obtain the video frame.

(Specific Example of Step S102)

As in the first specific example, the video recognizing section 11A of the user terminal 10A inputs the video frame into the detection model, and then obtains (i) the object ID, which is 1, of the object OBJ and (ii) a first area Area1 that is in the video frame and that includes the object OBJ. It is assumed that, in so doing, the video recognizing section 11A calculates 0.3 as the recognition confidence C1. This is because, since the object OBJ has moved relatively far as compared with the first specific example, the recognition confidence C1 calculated by the video recognizing section 11A has become lower than that in the first specific example.

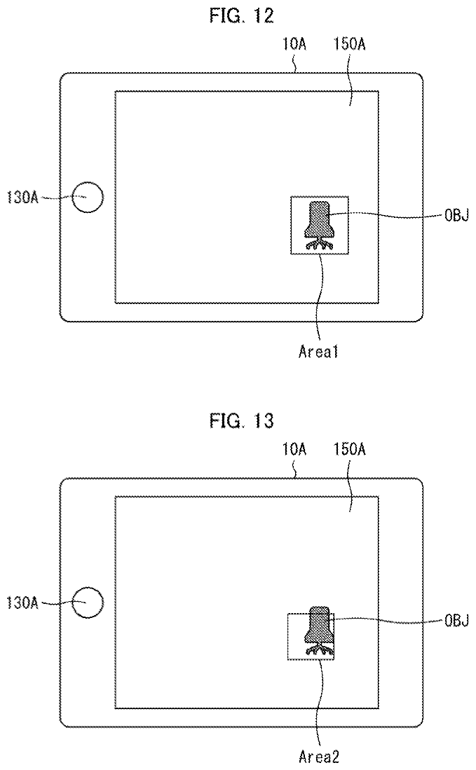

FIG. 12 is a schematic view illustrating the first area Area1 detected by the video recognizing section 11A. As illustrated in FIG. 12, in the second specific example, the video recognizing section 11A detects, in the video frame, the first area Area1 that includes the object OBJ and that is rectangular. Note that FIG. 12 is a schematic view illustrating the first area Area1, and does not necessarily impose a limitation that a rectangle indicating the first area Area1 is displayed by the display 150A in this step.

(Specific Examples of Steps S103 and S104)

Note, here, that, as illustrated in FIG. 10, the object information 22A pertaining to the object OBJ is stored in the object map in the server 20A. Therefore, the local position estimating section 13A obtains, in the step S103, the object information 22A illustrated in FIG. 10. Since the local position estimating section 13A has been able to obtain the object information 22A, the local position estimating section 13A makes a determination as “YES” in the step S104.

(Specific Example of Step S105)

In the step S105, the self-position estimating section 12A estimates, as the position and the direction of the user terminal 10A, a position P1 and a direction d1 in the global coordinate system. Further, the self-position estimating section 12A calculates 0.95 as the position confidence D2 in these results of estimation.

(Specific Example of Step S106)

FIG. 13 is a schematic view illustrating a second area Area2 estimated by the local position estimating section 13A in the step S106. As illustrated in FIG. 13, the second area Area2 is represented as a rectangle in a screen coordinate system (bounding box). Note that FIG. 13 is a schematic view illustrating the second area Area2, and does not necessarily impose a limitation that a rectangle indicating the second area Area2 is displayed by the display 150A in this step.

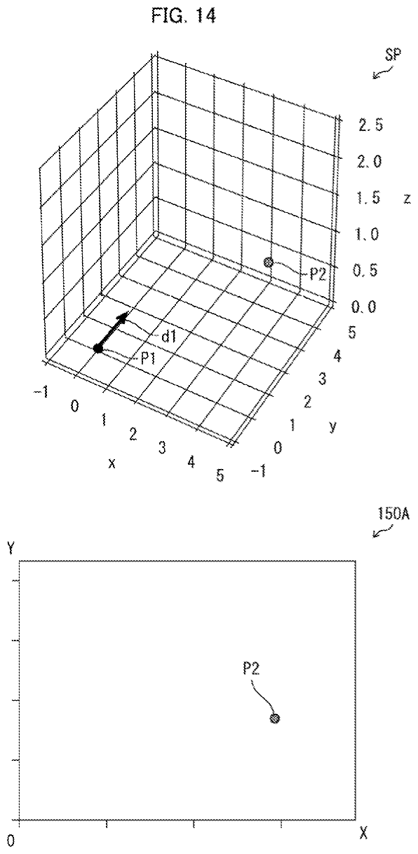

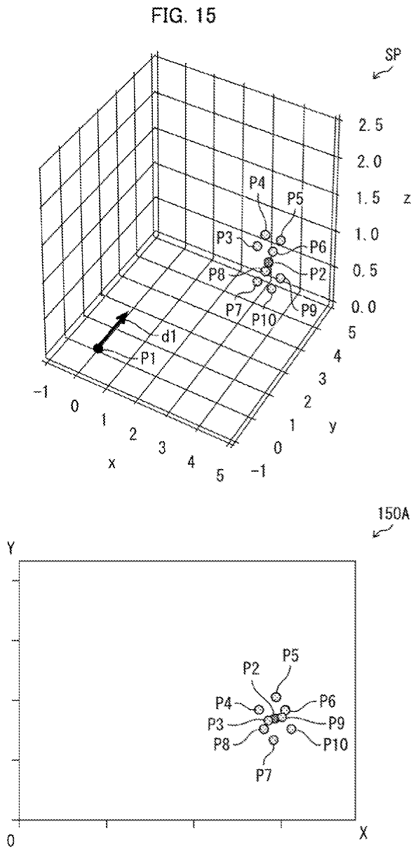

A specific example of a process in which the local position estimating section 13A estimates the second area Area2 in the screen coordinate system is described with reference to the following expression (3) and FIGS. 14 and 15.

$$[ \begin{matrix}\begin{matrix}x \\ y\end{matrix} \\ z\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}\begin{matrix}\begin{matrix}X \\ Y\end{matrix} \\ Z\end{matrix} \\ 1\end{matrix} ] \qquad ( 3 )$$

$${x}^{′} = \frac{x}{z} {y}^{′} = \frac{y}{z}$$

$$u = {f}_{x} * {x}^{′} + {c}_{x}$$

$$v = {f}_{y} * {y}^{′} + {c}_{y}$$

First the local position estimating section 13A converts global coordinates (X, Y, Z) included in the object information 22A into screen coordinates (u, v) with use of the expression (3). Note, here, that the global coordinates (X, Y, Z) represent a center point of the object OBJ in the global coordinate system. Note also that r11 to r33 are rotation parameters, and t1 to t3 are movement parameters. These parameters are each calculated from the position P1 and the direction d1 of the terminal. Note also that fx, fy, cx, and cy are inner parameters of the camera 130A. Note that the expression (3) is a method in which distortion of a pinhole camera is not considered. Instead of the expression (3), the local position estimating section 13A may use a method in which the distortion is considered. Alternatively, the local position estimating section 13A may use, instead of the expression (3), a method that varies depending on a type of the camera 130A.

FIG. 14 is a schematic view illustrating a process of converting the global coordinates (X, Y, Z) of the center point of the object OBJ into the screen coordinates (u, v). An upper part of FIG. 14 illustrates the position P1 and the direction d1 of the user terminal 10A and a center point P2 of the object OBJ in the global coordinate system. A lower part of FIG. 14 illustrates the center point P2 of the object OBJ in the screen coordinate system.

Next, on the basis of the size, which is 0.5 (m) and which is included in the object information 22A, of the object OBJ, the local position estimating section 13A virtually forms a regular hexahedron of which a center corresponds to the center point of the object OBJ and of which a side has a length of 0.5 (m). The local position estimating section 13A converts global coordinates of eight vertices of the virtually formed regular hexahedron into the screen coordinate system with use of the expression (3).

FIG. 15 is a schematic view illustrating a process of converting the global coordinates of the eight vertices of the virtually formed regular hexahedron into screen coordinates. An upper part of FIG. 15 illustrates, in the global coordinate system, the eight vertices P3 to P10 of the regular hexahedron of which the center corresponds to the position P2. A lower part of FIG. 15 illustrates the eight vertices P3 to P10 that have been converted into the screen coordinate system.

Next, in the screen coordinate system, the local position estimating section 13A calculates, as the second area Area2, a bounding box that includes all of the vertices P3 to P10.

(Specific Examples of Steps S107 and S108)

In the step S107, the local position estimating section 13A outputs the recognition confidence C6 which is included in the object information 22A pertaining to the object OBJ and which is 0.9. Further, as the position confidence D3, the local position estimating section 13A multiplies the position confidence D2, which is in the position P1 of the user terminal 10A and which is 0.95, and the position confidence D6, which is included in the object information 22A and which is 0.9. Consequently, the position confidence D3, which is 0.855, is calculated. It is assumed that the position confidence D3 is equal to or higher than the threshold α1. Thus, the local position estimating section 13A makes a determination as “YES” in the step S108.

(Specific Example of Step S109)

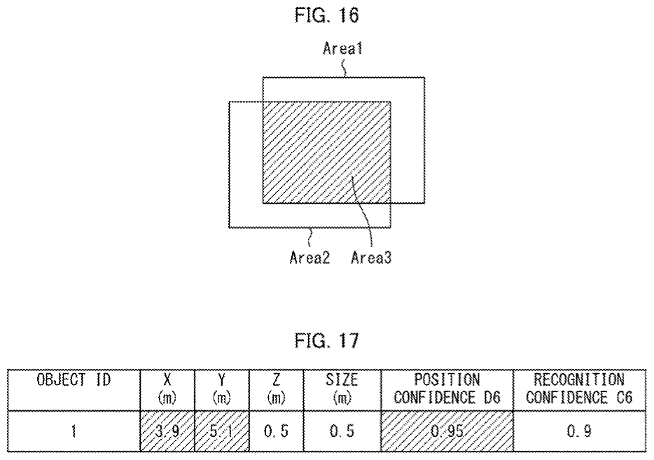

FIG. 16 is a schematic view illustrating the IoU calculated by the integrating section 14A in the step S109. As illustrated in FIG. 16, in the screen coordinate system, an area in which the first area Area1 calculated by the video recognizing section 11A and the second area Area2 estimated by the local position estimating section 13A overlap with each other (area filled with diagonal patterns) is referred to as a third area Area3. The integrating section 14A calculates, as the IoU, a value obtained by dividing an area of the third area Area3 by an area of a combined area obtained by combining the first area Area1 and the second area Area2. It is assumed, here, that 0.8 is calculated as the IoU. It is assumed that the IoU is equal to or higher than the threshold α2. Therefore, the integrating section 14A makes a determination as “YES” in the step S110.

(Specific Example of Step S111)

In the step S111, the integrating section 14A calculates the recognition confidence C4 with use of the expression (2). Specifically, the integrating section 14A sets, as the recognition confidence C4, 0.9 that is a maximum value out of the recognition confidence C1, which is 0.3 and which has been calculated by the video recognizing section 11A, and the recognition confidence C6, which is 0.9 and which has been outputted by the local position estimating section 13A. In this specific example, the threshold α3 for determining whether or not to employ a result of detection by the video recognizing section 11A is 0.5. Since the recognition confidence C4, which is 0.9 and which has been calculated by the integrating section 14A, is equal to or higher than the threshold α3, which is 0.5, the integrating section 14A makes a determination as “YES” in the step S113.

(Specific Example of the Step S114)

On the assumption that the object OBJ has been able to be detected, the integrating section 14A employs and outputs, as a result of detection, the first area Area1 detected by the video recognizing section 11A. The integrating section 14A transmits, to the server 20A, the object ID, which is 1, and the first area Area1 that are the result of the detection, the recognition confidence C4, which is 0.9, and the position and the direction of the user terminal 10A. In this manner, in the second specific example, even in a case where the recognition confidence C1 calculated by the video recognizing section 11A is low, it is possible to detect the object OBJ with high accuracy by integrating the result of the recognition by the video recognizing section 11A and the result of the recognition by the local position estimating section 13A.

(Specific Examples of Steps S201 and S202)

The global position estimating section 21A of the server 20A receives the above result of the detection and the recognition confidence C4, which is 0.9, from the user terminal 10A. Further, since the received recognition confidence C4, which is 0.9, is equal to or higher than the threshold α4, the global position estimating section 21A makes a determination as “YES” in the step S202.

(Specific Example of Step S203)

In the step S203, the global position estimating section 21A estimates a global position of the object OBJ on the basis of (i) the result of the detection received from the user terminal 10A and (ii) the position and the direction of the user terminal 10A. It is assumed, here, that, as the global position, a position (X=3.9 (m: meter), Y=5.1 (m), Z=0.5 (m)) which differs from the global position that is already included in the object information 22A is estimated. Further, the global position estimating section 21A calculates 0.7, which is lower than that in the first specific example, as the position confidence D5 in a result of estimation. This is because, in the second specific example, a distance from the user terminal 10A to the object OBJ is longer than that in the first specific example.

(Specific Examples of Steps S204 to S206)

In the step S204, the global position estimating section 21A calculates, as the confidence score Score1, 1.6 that is a sum of the recognition confidence C4, which is 0.9 and which has been received from the integrating section 14A, and the calculated position confidence D5, which is 0.7.

Further, since the object information 22A is accumulated in the object map, the global position estimating section 21A makes a determination as “YES” in the step S205 and carries out the step S206. That is, the global position estimating section 21A calculates, as the confidence score Score2, 1.8 that is a sum of the recognition confidence C6, which is 0.9, and the position confidence D6, which is 0.9, that are included in the object information 22A.

(Specific Examples of Steps S207 and S208)

Here, since Score1 is not higher than Score2, the global position estimating section 21A makes a determination as “NO” in the step S207, and ends the detection method S20A. That is, the global position estimating section 21A does not update the object information 22A accumulated in the object map.

In this manner, in the second specific example, even in a case where the user moves far away from the object OBJ, it is possible to detect the object OBJ with high accuracy. Note, however, that the object information 22A that indicates a result of previous detection is not updated by the result of the detection carried out in a case where the user moves far away from the object OBJ.

### Third Specific Example: Detecting Object OBJ Again

Thereafter, it is assumed that, as illustrated in FIG. 9, the user U has moved close to the object OBJ again.

(Specific Examples of Steps S101 to S114)

In the third specific example, the user terminal 10A carries out the detection method S10A in the almost same manner as that in the second specific example. In the third specific example, since the distance from the user terminal 10A to the object OBJ is shorter than that in the second specific example, the value of the recognition confidence C1 calculated in the step S102 is higher than that in the second specific example. Note, however, that it is assumed that the value of the recognition confidence C4 outputted from the user terminal 10A to the server 20A in the step S114 is the same as that in the second specific example, i.e., 0.9.

(Specific Examples of Steps S201 to S206)

In the third specific example, the server 20A carries out the steps S201 to S206 of the detection method S20A in the almost same manner as that in the second specific example. Note, however, that, a difference is that, as the position confidence D5, 0.95, which is higher than that in the second specific example, is calculated in the step S203. This is because, in the third specific example, the distance from the user terminal 10A to the object OBJ is shorter than that in the second specific example. Consequently, another difference is that, as the confidence score Score1, 1.85, which is higher than that in the second specific example, is calculated in the step S204. The value of the confidence score Score1, i.e., 1.85, is a sum of the recognition confidence C4, which is 0.9 and which has been received from the integrating section 14A, and the calculated position confidence D5, which is 0.95.

(Specific Examples of Steps S207 and S208)

Here, since Score1 is higher than Score2, the global position estimating section 21A makes a determination as “YES” in the step S207, and carries out the step S208. That is, the global position estimating section 21A updates the object information 22A accumulated in the object map.

FIG. 17 illustrates the updated object information 22A. As illustrated in FIG. 17, the global position included in the object information 22A is updated to (X=3.9 (m: meter), Y=5.1 (m), Z=0.5 (m)). The recognition confidence C6 is not updated because the value, i.e., 0.9, that is already stored is the same as the value, i.e., 0.9, of the recognition confidence C4 received from the user terminal 10A. The position confidence D6 is updated to the position confidence D5, which is 0.95 and which has been calculated by the global position estimating section 21A.

In this manner, in the third specific example, in a case where the user becomes close to the object OBJ again, it is possible to detect the object OBJ with high accuracy. Further, the object information 22A that indicates the result of the previous detection is updated by a result of detection carried out in a case where the user becomes close to the object OBJ again. Therefore, it is possible for the detection system 1A to detect even a moving object OBJ with high accuracy.

### Effects of the Second Example Embodiment

In the second example embodiment, it is possible to detect an object with high accuracy without requiring the user terminal 10A to have high processing performance. Reasons for this are as follows.

First, a case where AR is realized in the user terminal 10A is considered. In this case, it is required that a processing speed, from when the camera 130A generates a video frame to when the video frame on which a virtual object is superimposed is displayed by the display 150A, be short. That is, it is desirable that the processing speed at which the user terminal 10A detects an object be as short as possible. In the second example embodiment, it is possible to increase, by a result of detection by the local position estimating section 13B, accuracy of detection by the video recognizing section 11A. As a result, the video recognizing section 11A does not need to be realized with use of a highly-accurate video recognition technique which requires a terminal to have high processing performance. Therefore, in the second example embodiment, it is possible to detect an object at a high speed and with high accuracy, regardless of processing performance of the user terminal 10A.

Moreover, in the second example embodiment, it is possible to detect even a moving object more accurately. Reasons for this are as follows.

It is considered that, as an object to be recognized becomes farther from the user terminal 10A, accuracy of detection by the video recognizing section 11A becomes lower. In the second example embodiment, in a case where an object is close to the user terminal 10A (for example, the first specific example), the video recognizing section 11A outputs a result of detection in which a degree of confidence (the recognition confidence C1) is high. The local position estimating section 13A does not output a result of detection unless object information 22A is registered in the object map. In this case, the integrating section 14A outputs a result of detection with use of merely the result of the detection which has been carried out by the video recognizing section 11A and in which the degree of confidence is high. In the object map, a global position of the object, recognition confidence, and position confidence are recorded. In this case, as the object becomes closer, values of the position confidence and the recognition confidence to be recorded in the global map become higher.

Next, in a case where the user terminal 10A moves, the object moves relatively far from the user terminal 10A (for example, the second specific example). In this case, the video recognizing section 11A outputs a result of detection in which a degree of confidence (the recognition confidence C1) is low. The local position estimating section 13A estimates a local position on the basis of the object information 22A stored in the object map. The integrating section 14A integrates the result of the detection by the video recognizing section 11A and a result of detection by the local position estimating section 13A. Thus, even in a case where the degree of confidence in the result of the detection by the video recognizing section 11A is low, it is possible to employ the result of the detection. As a result, accuracy of detection is improved.

Further, in a case where the object itself moves, IoU often becomes equal to or lower than a threshold. In this case, a result of detection by the local position estimating section 13A is not subjected to integration. Therefore, a result of previous detection of the object which has moved is not referred to, and a result of detection by the video recognizing section 11A is employed as a result of detection. By, in this manner, not referring to a result of previous detection of a moving object, accuracy of detection is improved, as compared with the technique disclosed in Non-Patent Literature 1 in which a result of previous detection of a moving object is referred to.

### Third Example Embodiment

The following description will discuss, in detail, a third example embodiment of the present invention with reference to a drawing. Note that elements having the same functions as those of the elements described in the first and second example embodiments are denoted by the same reference numerals, and descriptions thereof will not be repeated.

<Configuration of Detection System>

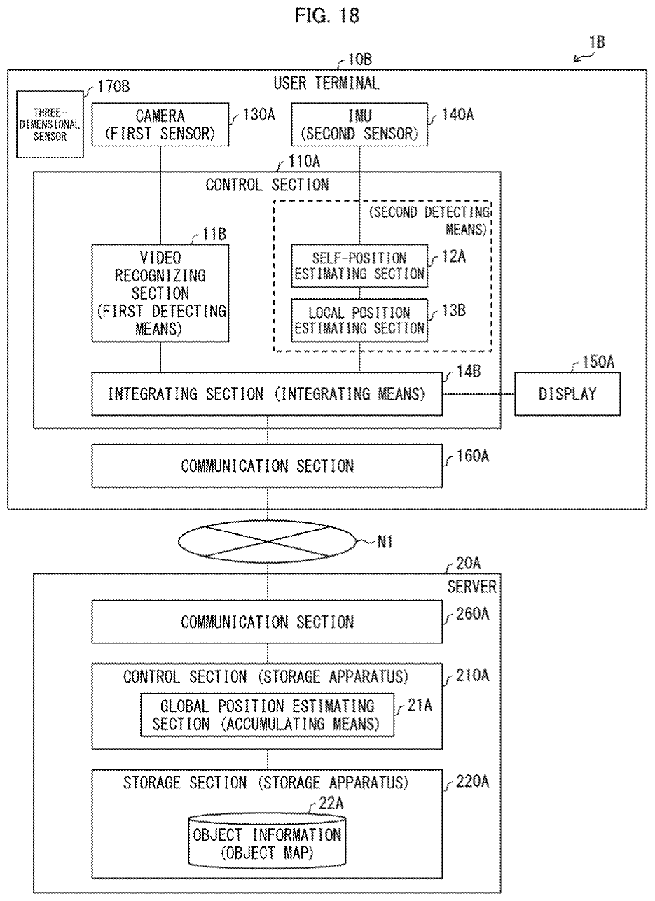

A configuration of a detection system 1B according to the third example embodiment is described with reference to FIG. 18. FIG. 18 is a block diagram illustrating the configuration of the detection system 1B. The detection system 1B is configured in substantially the same manner as the detection system TA according to the second example embodiment, but differs from the detection system TA in that the detection system 1B includes a user terminal 10B instead of the user terminal 10A. The user terminal 10B is configured in substantially the same manner as the user terminal 10A according to the second example embodiment, but differs from the user terminal 10A in that the user terminal 10B further includes a three-dimensional sensor 170B. Another difference is that the user terminal 10B includes a video recognizing section 11B, a local position estimating section 13B, and an integrating section 14B, instead of the video recognizing section 11A, the local position estimating section 13A, and the integrating section 14A.

(Three-Dimensional Sensor)

The three-dimensional sensor 170B is a sensor that obtains depth information pertaining to an object OBJ. For example, the three-dimensional sensor 170B may be, but is not limited to, an infrared sensor, three-dimensional LiDar, or a stereo camera.

(Video Recognizing Section)

The video recognizing section 11B is configured in substantially the same manner as the video recognizing section 11A according to the second example embodiment, but differs from the video recognizing section 11A in that the video recognizing section 11B uses the depth information in addition to a video frame and outputs information indicating a three-dimensional first area. In other words, the video recognizing section 11B analyzes three-dimensional data obtained by adding the depth information to the video frame, instead of analyzing the video frame that is a two-dimensional image.

Specifically, the video recognizing section 11B detects the object with use of a detection model that has been trained by machine learning so as to detect a three-dimensional area of the object from the video frame and the depth information. For example, the video frame and the depth information are inputted into the detection model, and then the detection model outputs an object ID of the object that has been detected, information indicating the three-dimensional first area that includes the object, and recognition confidence C1 of the object that has been detected. The information indicating the three-dimensional first area is represented by, for example, a camera coordinate system. Note, here, that the camera coordinate system is a three-dimensional coordinate system of which an origin corresponds to a position of the user terminal 10B. Such a detection model can be generated with use of training data in which a video frame that includes an object to be recognized and depth information that has been simultaneously obtained are associated with a correct three-dimensional first area.

(Local Position Estimating Section)

The local position estimating section 13B is configured in substantially the same manner as the local position estimating section 13A according to the second example embodiment, but differs from the local position estimating section 13A in that the local position estimating section 13B three-dimensionally calculates a local position of the object and a second area.

Specifically, the local position estimating section 13B estimates, with reference to accumulated object information 22A and a position and a direction of the user terminal 10B, the local position of the object in a three-dimensional coordinate system (i.e., camera coordinate system) of which an origin corresponds to the position of the user terminal 10B. Specifically, the local position estimating section 13B converts, into camera coordinates in the camera coordinate system, global coordinates which indicate a global position and which are included in the accumulated object information 22A, on the basis of the position and the direction of the user terminal 10B. A result obtained by this coordinate conversion is the local position.

Further, the local position estimating section 13B calculates a three-dimensional second area that is in the camera coordinate system and that includes the object, on the basis of the calculated local position and size information included in the object information 22A. For example, as the three-dimensional second area that includes the object, the local position estimating section 13B calculates, in the camera coordinate system, an area of a regular hexahedron of which a center corresponds to the local position and of which a side has a length indicated by the size information.

The local position estimating section 13B calculates position confidence D3 relating to a position of the three-dimensional second area. A method for calculating the position confidence D3 is the same as that carried out by the local position estimating section 13A.

(Integrating Section)

The integrating section 14B is configured in substantially the same manner as the integrating section 14A according to the second example embodiment, but differs from the integrating section 14A in that the integrating section 14B three-dimensionally calculates IoU.

Specifically, the integrating section 14B determines a volume of a part shared by the three-dimensional first area (e.g., rectangular parallelepiped) detected by the video recognizing section 11B and the three-dimensional second area (in the above-described example, regular hexahedron) detected by the local position estimating section 13B. Further, the integrating section 14B determines a volume of a combined area obtained by combining the first area and the second area. The integrating section 14B calculates the IoU by dividing the volume of the above shared part by the volume of the combined area.

<Flow of Detection Method>

A detection method carried out by the detection system 1B configured as described above is substantially the same as the detection method S1A, which has been described with reference to FIG. 7, according to the second example embodiment, but differs from the detection method S1A in steps below. The other steps are as described in connection with the detection method S1A.

(Step S101)

In a step S101, the video recognizing section 11A obtains, from the three-dimensional sensor 170B, depth information in addition to a video frame. The step S101 is the same as the above-described step S101 in the other points.

(Step S102)

In a step S102, the video recognizing section 11B outputs information indicating a three-dimensional first area in a camera coordinate system. The step S102 is the same as the above-described step S102 in the other points.

(Step S106)

In a step S106, the local position estimating section 13B calculates a three-dimensional second area in the camera coordinate system. The step S106 is the same as the above-described step S106 in the other points.

(Step S109)

In a step S109, the integrating section 14B calculates IoU with reference to the three-dimensional first area and the three-dimensional second area. The step S109 is the same as the above-described step S109 in the other points.

### Effects of the Third Example Embodiment

In the third example embodiment, a first detecting section and a second detecting section three-dimensionally detect an object. It is therefore possible to detect the object more accurately.

### Fourth Example Embodiment

The following description will discuss, in detail, a fourth example embodiment of the present invention with reference to a drawing. Note that elements having the same functions as those of the elements described in the first to third example embodiments are denoted by the same reference numerals, and descriptions thereof will not be repeated.

<Configuration of Detection System>

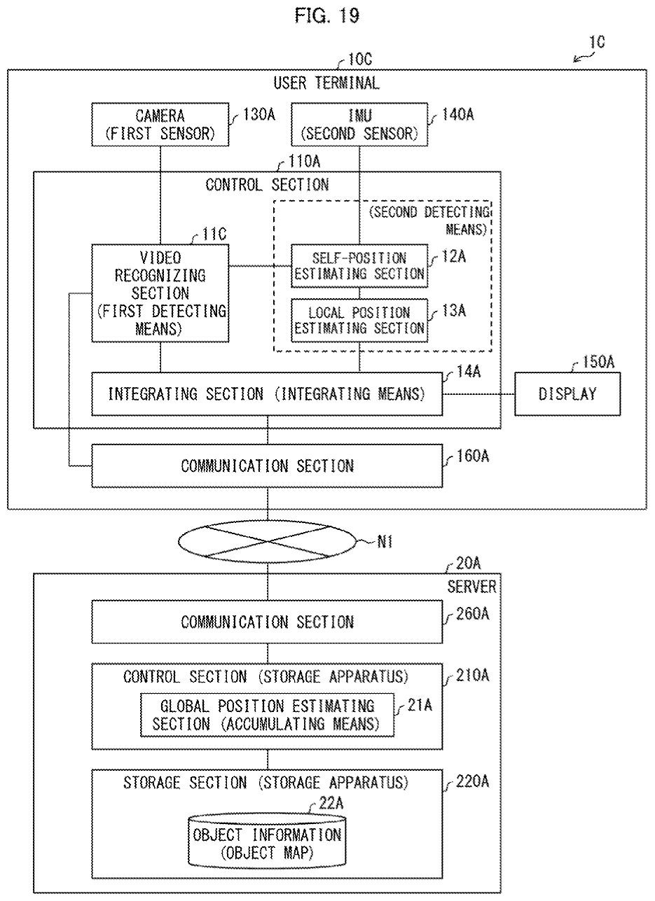

A configuration of a detection system 1C according to the third example embodiment is described with reference to FIG. 19. FIG. 19 is a block diagram illustrating the configuration of the detection system 1C. The detection system 1C is configured in substantially the same manner as the detection system TA according to the second example embodiment, but differs from the detection system TA in that the detection system 1C includes a user terminal 10C instead of the user terminal 10A. The user terminal TOC is configured in substantially the same manner as the user terminal 10A according to the second example embodiment, but differs from the user terminal 10A in that the user terminal 10C includes a video recognizing section 11C instead of the video recognizing section 11A.

(Video Recognizing Section 11C)

The video recognizing section 11C is configured in substantially the same manner as the video recognizing section 11A according to the second example embodiment, but differs from the video recognizing section 11A in that the video recognizing section 11C further refers to (i) information pertaining to a size of an object and (ii) a position and a direction of the user terminal TOC, in addition to referring to a video frame. It is possible for the video recognizing section 11C to estimate the size of the object on the video frame with use of information pertaining to an actual size of the object and information pertaining to the position and the direction of the user terminal TOC.

Specifically, the video recognizing section 11C obtains the information pertaining to the size of the object with reference to object information 22A. For example, a server 20A may be configured to transmit, to the user terminal 10A, the information pertaining to the size of the object periodically or at a timing when the object information 22A is updated. The video recognizing section 11C may obtain the information by periodically requesting the object information 22A from the server 20A.

Further, the video recognizing section 11C obtains, from a self-position estimating section 12A, the information indicating the position and the direction of the user terminal 10C.

Further, a detection model used by the video recognizing section 11C is configured in substantially the same manner as the detection model used by the video recognizing section 11A according to the second example embodiment, but differs from the detection model used by the video recognizing section 11A in that the detection model outputs a plurality of candidate areas that can each include the object. The plurality of candidate areas differ from each other at least in size. In this case, with reference to the position and the direction of the user terminal 10C, the video recognizing section 11C selects, from among the plurality of candidate areas, a candidate area having a size consistent with the size of the object that can be included in the video frame. The video recognizing section 11C then outputs the selected candidate area as a first area.

A case where the video recognizing section 11C uses another video recognition technique is described. In this case, it is assumed that the video recognition technique detects a plurality of candidate areas that each include the object. In this case, as in a case where the detection model is used, it is possible for the video recognizing section 11C to select, from among the plurality of candidate areas, a candidate area having a size consistent with the size of the object that can be included in the video frame, with reference to the position and the direction of the user terminal 10C.

<Flow of Detection Method>

A detection method carried out by the detection system 1C configured as described above is substantially the same as the detection method S1A, which has been described with reference to FIG. 7, according to the second example embodiment, but differs from the detection method S1A in steps below. The other steps are as described in connection with the detection method S1A.

(Step S102)

In a step S102, with reference to information pertaining to a size of an object and information indicating a position and a direction of the user terminal 10C in addition to a video frame, the video recognizing section 11C detects a first area having a size consistent with a size of the object that can be included in the video frame.

### Effects of the Fourth Example Embodiment

In the fourth example embodiment, it is possible to improve accuracy of detection by the video recognizing section 11C, by considering information which pertains to a size of an object and which is included in object information 22A. As a result, in the fourth example embodiment, it is possible to detect an object more accurately.

### Fifth Example Embodiment

The following description will discuss, in detail, a fifth example embodiment of the present invention with reference to a drawing. Note that elements having the same functions as those of the elements described in the first to fourth example embodiments are denoted by the same reference numerals, and descriptions thereof will not be repeated.

<Configuration of Detection System>

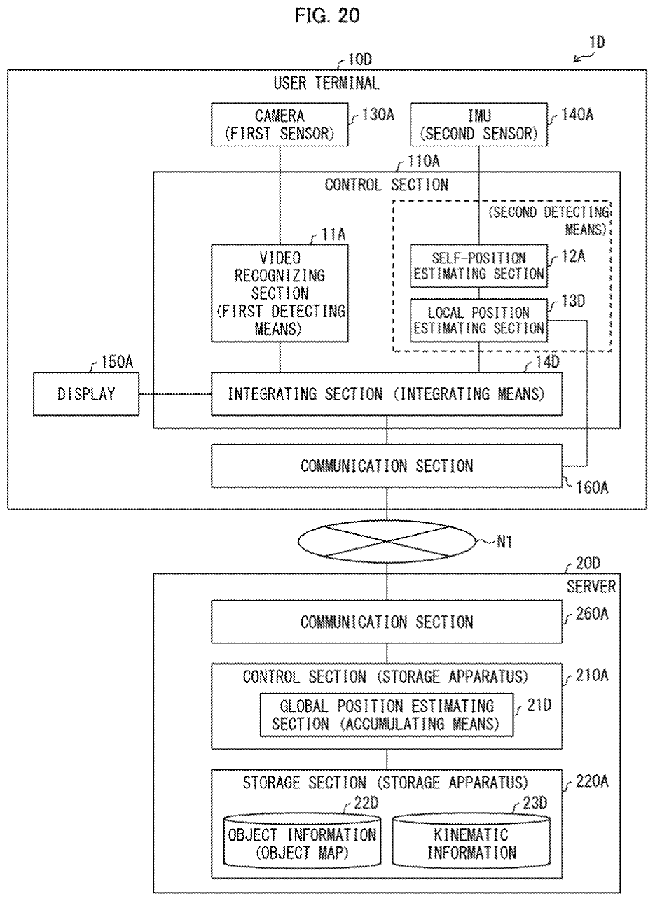

A configuration of a detection system 1D according to the fifth example embodiment is described with reference to FIG. 20. FIG. 20 is a block diagram illustrating the configuration of the detection system 1D. The detection system 1D includes a user terminal 10D and a server 20D. The user terminal 10D is configured in substantially the same manner as the user terminal 10A according to the second example embodiment, but differs from the user terminal 10A in that the user terminal 10D includes a local position estimating section 13D and an integrating section 14D instead of the local position estimating section 13A and the integrating section 14A. The server 20D is configured in substantially the same manner as the server 20A according to the example embodiment, but differs from the server 20A in that the server 20D includes a global position estimating section 21D, instead of the global position estimating section 21A. Further, the server 20D differs from the server 20A in that object information 22D, instead of the object information 22A, is stored in a storage section 220A. Moreover, the server 20D differs from the server 20A in that kinematic information 23D is further stored in the storage section 220A.

(Kinematic Information)

The kinematic information 23D is information indicating a feature relating to movement of an object. The kinematic information 23D is stored in association with an object ID. The kinematic information 23D includes, for example, an average moving speed of the object, a maximum moving speed of the object, or a probability distribution concerning a moving speed of the object.

(Object Map)

In an object map, the object information 22D is stored, instead of the object information 22A, for each object. In addition to the items described with reference to FIG. 6, the object information 22D further includes a detection time. The detection time indicates a time when the object has been most recently detected.

(Global Position Estimating Section)

The global position estimating section 21D is configured in substantially the same manner as the global position estimating section 21A according to the second example embodiment, but differs from the global position estimating section 21A in that the global position estimating section 21D further includes the detection time in the object information 22D to be accumulated in the object map. For example, the global position estimating section 21D may use, as the detection time to be included in the object information 22D, a time when the global position estimating section 21D has received a result of detection from the integrating section 14D or a time when the global position estimating section 21D adds or updates the object information 22D, but is not limited to these examples.

(Local Position Estimating Section)

The local position estimating section 13D is configured in substantially the same manner as the local position estimating section 13A according to the second example embodiment, but differs from the local position estimating section 13A in that the local position estimating section 13D refers to the kinematic information 23D in addition to the accumulated object information 22D and a position and a direction of the user terminal 10A.

Specifically, the local position estimating section 13D estimates a second area that includes a current object, with reference to the kinematic information 23D and the time when the object has been detected. For example, in a case where the kinematic information includes the probability distribution concerning movement, the local position estimating section 13D estimates probability distribution P(x, y) of the second area from the detection time and the kinematic information 23D.

(Integrating Section)

The integrating section 14D is configured in substantially the same manner as the integrating section 14A according to the second example embodiment, but differs from the integrating section 14A in that the integrating section 14D uses a determination parameter instead of IoU. The determination parameter is determined by an accumulated value of the probability distribution of the second area in the first area. In this case, in a case where the determination parameter is equal to or higher than a threshold, the integrating section 14D operates in the same manner as a case where the IoU is equal to or higher than a threshold α2.

<Flow of Detection Method>

A detection method carried out by the detection system TD configured as described above is substantially the same as the detection method S1A, which has been described with reference to FIGS. 7 and 8, according to the second example embodiment, but differs from the detection method S1A in steps below. The other steps are as described in connection with the detection method S1A.

(Step S103)

In a step S103, the local position estimating section 13D requests, from the server 20A, kinematic information 23D, in addition to object information 22D. The step S103 is the same, in the other points, as the step S103 described in connection with the second example embodiment.

(Step S104)

In a step S104, the local position estimating section 13D determines whether or not the local position estimating section 13D has been able to obtain the object information 22D and the kinematic information 23D. In a case where the local position estimating section 13D has been able to obtain both of the object information 22D and the kinematic information 23D, the local position estimating section 13D makes a determination as “YES”. In a case where the local position estimating section 13D has been unable to obtain any one of the object information 22D and the kinematic information 23D, the local position estimating section 13D makes a determination as “NO”. The step S104 is the same, in the other points, as the step S104 described in connection with the second example embodiment.

(Step S106)

In a step S106, the local position estimating section 13D calculates a second area that includes a current object, with reference to the kinematic information 23D in addition to the accumulated object information 22D and a position and a direction of the user terminal 10A. It is assumed, here, that the kinematic information 23D includes a probability distribution concerning a moving speed. Thus, a probability distribution of the second area is calculated. The step S106 is the same, in the other points, as the step S106 described in connection with the second example embodiment.

(Step S109)

In a step S109, the integrating section 14D calculates a determination parameter from the first area and the probability distribution of the second area. The step S109 is the same, in the other points, as the step S109 described in connection with the second example embodiment.

(Step S110)

In a step S110, the integrating section 14D determines whether or not the determination parameter is equal to or higher than a threshold.

(Step S208)

In a step S208, the global position estimating section 21D includes a detection time into the object information 22D and adds the object information 22D to the object map, or updates the object information 22D by including the detection time thereinto. The step S208 is the same, in the other points, as the step S208 described in connection with the second example embodiment.

### Effects of the Fifth Example Embodiment

In the fifth example embodiment, kinematic information pertaining to an object is used. Thus, in a case where a first area detected by the video recognizing section 11A is highly likely to be a destination of movement from a position which has been previously detected, the first area is employed as a result of detection. In a case where the first area is unlikely to be the destination, the first area is not employed. Therefore, in the fifth example embodiment, it is possible to detect an object more accurately.

Note that, in the second to fifth example embodiments described above, some or all of the functional blocks included in the user terminal may be included in the server. Note also that some or all of the steps carried out by the user terminal may be carried out by the server. Note also that some or all of the functional blocks included in the server may be included in the user terminal. Note also that some or all of the steps carried out by the server may be carried out by the user terminal. The user terminal and the server may be configured as an integrated apparatus.

[Software Implementation Example]

A part or all of the functions of each of the detection system 1, the user terminals 10A, 10B, 10C, and 10D, and the servers 20A and 20D may be realized by hardware such as an integrated circuit (IC chip) or may be alternatively realized by software.

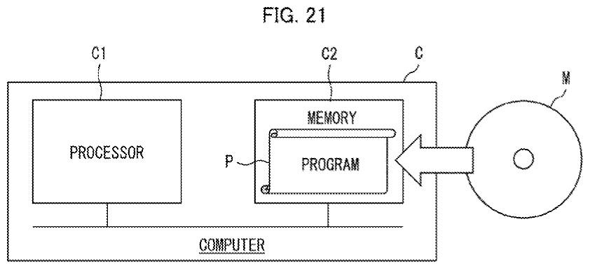

In the latter case, each of the detection system 1, the user terminals 10A, 10B, 10C, and 10D, and the servers 20A and 20D is realized by, for example, a computer which executes instructions of a program that is software realizing the functions. FIG. 21 illustrates an example of such a computer (hereinafter, referred to as “computer C”). The computer C includes at least one processor C1 and at least one memory C2. In the memory C2, a program P for causing the computer C to operate as each of the detection system 1, the user terminals 10A, 10B, 10C, and 10D, and the servers 20A and 20D is recorded. In the computer C, the functions of each of the detection system 1, the user terminals 10A, 10B, 10C, and 10D, and the servers 20A and 20D are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via such a recording medium M. The program P can also be transmitted via a transmission medium. Such a transmission medium can be, for example, a communication network, a broadcast wave, or the like. The computer C can acquire the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as follows. Note, however, that the present invention is not limited to the following example aspects.

(Supplementary Note 1)

A detection system including:
a first detecting means for detecting an object with reference to a value detected by a first sensor;
a second detecting means for detecting the object with reference to a result of previous detection of the object; and
an integrating means for detecting the object by integrating a result of detection by the first detecting means and a result of detection by the second detecting means.

With the above configuration, the object is detected by integrating (i) the result of the detection of the object which detection has been carried out with reference to the value detected by the first sensor and (ii) the result of the detection of the object which detection has been carried out with reference to the result of the previous detection. This makes it possible to detect the object more accurately, as compared with a case where only one of these results of detection is used.

(Supplementary Note 2)

The detection system according to Supplementary note 1, further including
an accumulating means for accumulating, in a storage apparatus, object information indicating the result of the previous detection, on the basis of a result of detection by the integrating means,
the second detecting means detecting the object with reference to the object information.

With the above configuration, it is possible to detect the object with reference to the result of the previous detection.

(Supplementary Note 3)

The detection system according to Supplementary note 1 or 2, wherein:
the first detecting means uses, as the first sensor, a camera provided to a user terminal, and detects the object with reference to an image captured by the camera; and
the second detecting means detects a relative position of the object as viewed from a position of the user terminal, with reference to, in addition to the result of the previous detection of the object, a value detected by a second sensor which detects the position and a direction of the user terminal.

With the above configuration, it is possible to detect the object by integrating (i) the result of the detection of the object which detection has been carried out with reference to the captured image and (ii) the result of the detection of the object which detection has been carried out in consideration of the result of the previous detection and the position/direction of the user terminal. This makes it possible to detect the object more accurately.

(Supplementary Note 4)

The detection system according to Supplementary note 3, wherein the second detecting means detects, as the relative position of the object, (i) a position of the object in a three-dimensional coordinate system of which origin corresponds to the position of the user terminal or (ii) a position of the object in a two-dimensional field-of-view image as viewed from the position of the user terminal.

With the above configuration, it is possible to detect the object more accurately on the basis of the result of the previous detection and the position/direction of the user terminal.

(Supplementary Note 5)

The detection system according to any one of Supplementary notes 1 to 4, wherein:
each of the first detecting means and the second detecting means calculates a degree of confidence in the result of the detection of the object; and
the integrating means integrates the result of the detection by the first detecting means and the result of the detection by the second detecting means with reference to the degree of confidence calculated by the first detecting means and the degree of confidence calculated by the second detecting means.

With the above configuration, it is possible to carry out integration, in consideration of the degree of confidence in each of the results of the detection, so as to obtain a result of detection in which a degree of confidence is higher.

(Supplementary Note 6)

The detection system according to Supplementary note 5, wherein the integrating means determines whether or not to refer to the degree of confidence calculated by the second detecting means, on the basis of whether or not a relationship between a position of the object which has been detected by the first detecting means and a position of the object which has been detected by the second detecting means satisfies a condition.

With the above configuration, in a case where the result of the detection which has been carried out with reference to the video frame and the result of the detection which has been carried out with reference to the result of the previous detection satisfy the condition in terms of a positional relationship, it is possible to employ the degree of confidence in the result of the previous detection.

(Supplementary Note 7)

The detection system according to any one of Supplementary notes 1 to 6, wherein the first detecting means further refers to information pertaining to a size of the object, in order to detect the object.

With the above configuration, it is possible to detect the object more accurately in consideration of the size of the object.

(Supplementary Note 8)

The detection system according to any one of claims 1 to 7, wherein the second detecting means further refers to kinematic information pertaining to the object, in order to detect the object.

With the above configuration, it is possible to detect a moving object more accurately in consideration of the kinematic information pertaining to the object.

(Supplementary Note 9)

The detection system according to Supplementary note 5, wherein:
the first detecting means calculates, as the degree of confidence, recognition confidence C1 which is a degree of confidence relating to recognition of the object that has been detected;
the second detecting means calculates, as the degree of confidence, (i) position confidence D3 which is a degree of confidence relating to a position of the object that has been detected and (ii) recognition confidence C6 which is a degree of confidence that is in the result of the previous detection and that relates to recognition; and
the integrating means integrates the result of the detection by the first detecting means and the result of the detection by the second detecting means on the basis of the recognition confidence C1, the position confidence D3, and the recognition confidence C6.

With the above configuration, it is possible to detect the object more accurately on the basis of the recognition confidence C1, the position confidence D3, and the recognition confidence C6.

(Supplementary Note 10)

The detection system according to Supplementary note 9, wherein:
the first detecting means uses, as the first sensor, a camera provided to a user terminal, and detects the object with reference to an image captured by the camera; and
the second detecting means
   detects a relative position of the object as viewed from a position of the user terminal, with reference to, in addition to the result of the previous detection of the object, a value detected by a second sensor which detects the position and a direction of the user terminal,
   calculates the position confidence D3 with reference to (i) position confidence D2 which is a degree of confidence relating to the position and the direction of the user terminal and (ii) position confidence D6 which is a degree of confidence that is in the result of the previous detection and that relates to the position, and
   calculates the position confidence D3 which becomes higher as at least one of the position confidence D2 and the position confidence D6 becomes higher.

With the above configuration, it is possible to determine the degree of confidence relating to the position of the object which position has been detected on the basis of the position and the direction of the user terminal and the result of the previous detection.

(Supplementary Note 11)

The detection system according to Supplementary note 9 or 10, wherein the integrating means
calculates, as a degree of confidence which is in a result of detection by the integrating means and which relates to recognition, recognition confidence C4 with reference to the recognition confidence C1 and the recognition confidence C6, and calculates the recognition confidence C4 which becomes higher as at least one of the recognition confidence C1 and the recognition confidence C6 becomes higher.

With the above configuration, it is possible to increase the degree of confidence in the result of the detection by the integrating section, in a case where one of the degree of confidence in the result of the detection by the first detecting means and the degree of confidence in the result of the detection by the second detecting means is high even when the other is low.

(Supplementary Note 12)

The detection system according to Supplementary note 2, wherein the accumulating means estimates a position of the object in a reality space with reference to the result of the detection by the integrating means, includes the position thus estimated into the object information, and accumulates the object information.

With the above configuration, it is possible to accumulate the result of the previous detection as a global position which is easy to refer to regardless of a change in position of the user terminal.

(Supplementary Note 13)

The detection system according to Supplementary note 2 or 12, wherein the accumulating means determines whether or not to update the object information, with reference to recognition confidence C4 which is a degree of confidence in the result of the detection by the integrating means.

With the above configuration, since it is determined, in accordance with the degree of confidence in the result of the detection, whether or not to update the result of the previous detection, it is possible to accumulate more accurate information as the result of the previous detection.

(Supplementary Note 14)

The detection system according to Supplementary note 13, wherein, in order to determine whether or not to update the object information, the accumulating means further refers to position confidence D5 which is a degree of confidence in a position of the object in a reality space which position has been estimated on the basis of the result of the detection.

With the above configuration, since it is determined, in accordance with the degree of confidence in a result of estimation of the position in the reality space, whether or not to update the result of the previous detection, it is possible to accumulate more accurate information as the result of the previous detection.

(Supplementary Note 15)

The detection system according to Supplementary note 14, wherein:
in order to determine whether or not to update the object information, the accumulating means determines to update the object information, in a case where a confidence score which has been calculated with reference to recognition confidence C4 and position confidence D5 is higher than a previous confidence score which has been calculated with reference to the object information; and
the accumulating means calculates the confidence score so that the confidence score does not become low in a case where at least one of the recognition confidence C4 and the position confidence D5 becomes high.

With the above configuration, it is possible to accumulate information which is more accurate, as the result of the previous detection.

(Supplementary Note 16)

A detection method including:
detecting an object existing in a reality space, with reference to a value detected by a first sensor;
detecting the object with reference to a result of previous detection of the object; and
detecting the object by integrating (i) a result of detection which has been carried out with reference to the value detected by the first sensor and (ii) a result of detection which has been carried out with reference to the result of the previous detection.

With the above configuration, the same effect as that brought about by Supplementary note 1 is brought about.

(Supplementary Note 17)

A program for causing a computer to function as a detection system, the program causing the computer to function as:
a first detecting means for detecting an object existing in a reality space, with reference to a value detected by a first sensor;
a second detecting means for detecting the object with reference to a result of previous detection of the object; and
an integrating means for detecting the object by integrating a result of detection by the first detecting means and a result of detection by the second detecting means.

With the above configuration, the same effect as that brought about by Supplementary note 1 is brought about.

(Supplementary Note 18)

A detection system including at least one processor, the at least one processor carrying out: a first detecting process of detecting an object with reference to a value detected by a first sensor; a second detecting process of detecting the object with reference to a result of previous detection of the object; and an integrating process of detecting the object by integrating (i) a result of detection which has been carried out with reference to the value detected by the first sensor and (ii) a result of detection which has been carried out with reference to the result of the previous detection.

Note that the detection system may further include a memory. In the memory, a program for causing the at least one processor to carry out the first detecting process, the second detecting process, and the integrating process may be stored. Alternatively, this program may be recorded in a computer-readable non-transitory tangible recording medium.

### REFERENCE SIGNS LIST

1, 1A, 1B, 1C, 1D Detection system
10, 10A, 10B, 10C, 10D User terminal
170B Three-dimensional sensor
11 First detecting section
12 Second detecting section
11A, 111B, 11C Video recognizing section
12A Self-position estimating section
13A, 13B, 13D Local position estimating section
14, 14A, 14B, 14D Integrating section
20, 20A, 20D Server
21A, 21D Global position estimating section
22A, 22D Object information
23D Kinematic information
110A, 210A Control section
130A Camera
140A IMU
150A Display
160A, 260A Communication section
220A Storage section

What is claimed is:

1. A detection system comprising at least one processor,
the at least one processor carrying out:
a first detecting process of detecting an object with reference to a value detected by a first sensor;
a second detecting process of detecting the object with reference to a result of previous detection of the object; and
an integrating process of detecting the object by integrating a result of detection in the first detecting process and a result of detection in the second detecting process.

2. The detection system according to claim 1, wherein:
the at least one processor further carries out an accumulating process of accumulating, in a storage apparatus, object information indicating the result of the previous detection, on the basis of a result of detection in the integrating process,
in the second detecting process, the at least one processor detects the object with reference to the object information.

3. The detection system according to claim 1, wherein:
in the first detecting process, the at least one processor means-uses, as the first sensor, a camera provided to a user terminal, and detects the object with reference to an image captured by the camera; and
in the second detecting process, the at least one processor means-detects a relative position of the object as viewed from a position of the user terminal, with reference to, in addition to the result of the previous detection of the object, a value detected by a second sensor which detects the position and a direction of the user terminal.

4. The detection system according to claim 3, wherein, in the second detecting process, the at least one processor detects, as the relative position of the object, (i) a position of the object in a three-dimensional coordinate system of which origin corresponds to the position of the user terminal or (ii) a position of the object in a two-dimensional field-of-view image as viewed from the position of the user terminal.

5. The detection system according to claim 1, wherein:
in each of the first detecting process and the second detecting process, the at least one processor calculates a degree of confidence in the result of the detection of the object; and
in the integrating process, the at least one processor integrates the result of the detection in the first detecting process and the result of the detection in the second detecting process with reference to the degree of confidence calculated in the first detecting process and the degree of confidence calculated in the second detecting process.

6. The detection system according to claim 5, wherein, in the integrating process, the at least one processor means-determines whether or not to refer to the degree of confidence calculated in the second detecting process, on the basis of whether or not a relationship between a position of the object which has been detected in the first detecting process and a position of the object which has been detected in the second detecting process means-satisfies a condition.

7. The detection system according to claim 1, wherein, in the first detecting process, the at least one processor means-further refers to information pertaining to a size of the object, in order to detect the object.

8. The detection system according to claim 1, wherein, in the second detecting process, the at least one processor means-further refers to kinematic information pertaining to the object, in order to detect the object.

9. A detection method comprising:
detecting an object existing in a reality space, with reference to a value detected by a first sensor;
detecting the object with reference to a result of previous detection of the object; and
detecting the object by integrating (i) a result of detection which has been carried out with reference to the value detected by the first sensor and (ii) a result of detection which has been carried out with reference to the result of the previous detection.

10. A computer-readable non-transitory recording medium in which a program is recorded,
the program causing a computer to carry out:
a first detecting process of detecting an object existing in a reality space, with reference to a value detected by a first sensor;
a second detecting process of detecting the object with reference to a result of previous detection of the object; and
an integrating process of detecting the object by integrating a result of detection in the first detecting process and a result of detection in the second detecting process.
